(19) United States
(12) Patent Application Publication
(10) Pub. No.: US 2026/0271027 A1
(43) Pub. Date: Sep. 10, 2026

(54) USER EQUIPMENTS AND COMMUNICATION METHODS

(71) Applicant: SHARP KABUSHIKI KAISHA, Sakai City, Osaka (JP)

(72) Inventors: LIQING LIU, Sakai City, Osaka (JP); DAIICHIRO NAKASHIMA, Sakai City, Osaka (JP); WATARU OUCHI, Sakai City, Osaka (JP); SHOICHI SUZUKI, Sakai City, Osaka (JP); Ryunosuke SAKAMOTO, Sakai City, Osaka (JP)

(21) Appl. No.: 19/099,826

(22) PCT Filed: Aug. 1, 2023
(86) PCT No.: PCT/JP2023/028662

§ 371 Date: Jan. 30, 2025

(30) Foreign Application Priority Data
Aug. 4, 2022 (JP) 2022-124583

(51) Int. Cl. H04W 72/25; H04L 5/00

(52) U.S. Cl. CPC H04W 72/25; H04L 5/0007; H04L 5/0055

(57) ABSTRACT

A method by a user equipment (UE) is described. The method includes receiving a sidelink (SL) resource pool configuration, the SL resource pool configuration indicating a SL resource pool wherein the SL resource pool includes a first set of RB sets; receiving, from another UE, a physical sidelink shared channel (PSSCH) in one or multiple RB sets in the first set; determining a set of physical sidelink feedback channel (PSFCH) resources that are available for a PSFCH transmission with HARQ-ACK information in response to the PSSCH reception, wherein each PSFCH resource in the set comprises of an interlace in any RB set of the one or multiple RB sets in frequency domain, an OFDM symbol in time domain, and a cyclic shift pair index in code domain; and indexing each PSFCH resource in the set based on an RB set index, an interlace index, a cyclic shift pair index.

### TECHNICAL FIELD

The present disclosure relates to a user equipment, and a communication method.

### BACKGROUND ART

At present, as a radio access system and a radio network technology aimed for the fifth generation cellular system, technical investigation and standard development are being conducted, as extended standards of Long Term Evolution (LTE), on LTE-Advanced Pro (LTE-A Pro) and New Radio technology (NR) in The Third Generation Partnership Project (3GPP).

In the fifth generation cellular system, three services of enhanced Mobile BroadBand (eMBB) to achieve high-speed and large-volume transmission, Ultra-Reliable and Low Latency Communication (URLLC) to achieve low-latency and high-reliability communication, and massive Machine Type Communication (mMTC) to allow connection of a large number of machine type devices such as Internet of Things (IoT) have been demanded as assumed scenarios.

For example, wireless communication devices may communicate with one or more devices. For sidelink communication, two communication devices can communicate with each other via PC-5 interface. However, given the existing sidelink communication methods can not directly applied to unlicensed spectrum, the flexibility and/or the efficiency of the whole sidelink communication system would be limited. As illustrated by this discussion, systems and methods according to the present invention, supporting sidelink communication over unlicensed spectrum, which may improve the communication flexibility and/or efficiency, would be beneficial.

### BRIEF DESCRIPTION OF THE DRAWINGS

FIG. 1 is a block diagram illustrating one configuration of one or more base stations and one or more user equipments (UEs) in which systems and methods for determination of PSFCH resources may be implemented;

FIG. 2 is a diagram illustrating one example 200 of a resource grid;

FIG. 3 is a diagram illustrating one example 300 of common resource block grid, carrier configuration and BWP configuration by a UE 102 and a base station 160;

FIG. 4 is a diagram illustrating one 400 example of CORESET configuration in a BWP by a UE 102 and a base station 160;

FIG. 5 is a diagram illustrating one example 500 for interlaced resource blocks for transmission and reception;

FIG. 6 is a diagram illustrating one example 600 of interlaced mapping for a BWP;

FIG. 7 is a diagram illustrating one example 700 of a SL BWP and a resource pool within the SL BWP;

FIG. 8 is a diagram illustrating one example 800 of a resource pool configuration;

FIG. 9 is a diagram illustrating one example 900 of configurations of a SL BWP and SL resource pools;

FIG. 10 is a diagram illustrating one example 1000 of a slot with PSFCH resources in a resource pool;

FIG. 11 is a diagram illustrating one example 1100 of a resource pool configured with PSFCH resources.

FIG. 12 is a diagram illustrating one example 1200 of a set of cyclic shift pair;

FIG. 13 is a diagram illustrating one example 1300 of cyclic shifts for the cyclic shift pair index 0 and index 1;

FIG. 14 is a diagram illustrating one example 1400 of indexing PSFCH resources for a given PSSCH;

FIG. 15 illustrates various components that may be utilized in a UE;

FIG. 16 illustrates various components that may be utilized in a base station;

### DESCRIPTION OF EMBODIMENTS

A user equipment (UE) is described. The UE includes reception circuitry configured to receive the SL resource pool configuration, the SL resource pool configuration indicating a SL resource pool wherein the SL resource pool includes a first set of RB sets, and to receive, from another UE, a physical sidelink shared channel (PSSCH) in one or multiple RB sets in the first set; and control unit configured to determine a set of physical sidelink feedback channel (PSFCH) resources that are available for a PSFCH transmission with HARQ-ACK information in response to the PSSCH reception, wherein each PSFCH resource in the set comprises of an interlace in any RB set of the one or multiple RB sets in frequency domain, an OFDM symbol in time domain, and a cyclic shift pair index in code domain, and to index each PSFCH resource in the set based on an RB set index, an interlace index, a cyclic shift pair index.

A user equipment (UE) is described. The UE includes reception unit configured to receive a sidelink (SL) resource pool configuration, the SL resource pool configuration indicating a SL resource pool wherein the SL resource pool includes a first set of RB sets; transmission unit configured to transmit, to another UE, a physical sidelink shared channel (PSSCH) in one or multiple RB sets in the first set; and control unit configured to determine a set of physical sidelink feedback channel (PSFCH) resources that are available for a PSFCH transmission with HARQ-ACK information in response to the PSSCH transmission, wherein each PSFCH resource in the set comprises of an interlace in any RB set of the one or multiple RB sets in frequency domain, an OFDM symbol in time domain, and a cyclic shift pair index in code domain, and to index each PSFCH resource in the set based on an RB set index, an interlace index, a cyclic shift pair index.

A communication method by a user equipment (UE) is described. The method includes receiving a sidelink (SL) resource pool configuration, the SL resource pool configuration indicating a SL resource pool wherein the SL resource pool includes a first set of RB sets; receiving, from another UE, a physical sidelink shared channel (PSSCH) in one or multiple RB sets in the first set; determining a set of physical sidelink feedback channel (PSFCH) resources that are available for a PSFCH transmission with HARQ-ACK information in response to the PSSCH reception, wherein each PSFCH resource in the set comprises of an interlace in any RB set of the one or multiple RB sets in frequency domain, an OFDM symbol in time domain, and a cyclic shift pair index in code domain; and indexing each PSFCH resource in the set based on an RB set index, an interlace index, a cyclic shift pair index.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification (TS 38.331, 38.321, 38.300, 37.340, 38.211, 38.212, 38.213, 38.214, etc.) for the New Radio Access (NR) and Next generation—Radio Access Network (NG-RAN).

At least some aspects of the systems and methods disclosed herein may be described in relation to the 3GPP LTE, LTE-Advanced (LTE-A), LTE-Advanced Pro, New Radio Access (NR), and other 3G/4G/5G standards (e.g., 3GPP Releases 8, 9, 10, 11, 12, 13, 14, 15, 16, and/or 17, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, a relay node, etc. Examples of wireless communication devices include cellular phones, smart phones, personal digital assistants (PDAs), laptop computers, netbooks, e-readers, wireless modems, industrial wireless sensors, video surveillance, wearables, vehicles, roadside units, infrastructure devices, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a base station and a UE. It should also be noted that in NR, NG-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a base station to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The base stations may be connected by the NG interface to the 5G-core network (5G-CN). 5G-CN may be called as to NextGen core (NGC), or 5G core (5GC). The base stations may also be connected by the S1 interface to the evolved packet core (EPC). For instance, the base stations may be connected to a NextGen (NG) mobility management function by the NG-2 interface and to the NG core User Plane (UP) functions by the NG-3 interface. The NG interface supports a many-to-many relation between NG mobility management functions, NG core UP functions and the base stations. The NG-2 interface is the NG interface for the control plane and the NG-3 interface is the NG interface for the user plane. For instance, for EPC connection, the base stations may be connected to a mobility management entity (MME) by the S1-MME interface and to the serving gateway (S-GW) by the S1-U interface. The S1 interface supports a many-to-many relation between MMEs, serving gateways and the base stations. The S1-MME interface is the S1 interface for the control plane and the S1-U interface is the S1 interface for the user plane. The Uu interface is a radio interface between the UE and the base station for the radio protocol.

The radio protocol architecture may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the base station 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in base station on the network side) may perform functions (e.g., ciphering and integrity protection) for the control plane. The RLC and MAC sublayers (terminated in base station on the network side) may perform the same functions as for the user plane. The Radio Resource Control (RRC) (terminated in base station on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRB0 may be used for RRC messages using the common control channel (CCCH) logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by a network (e.g., base station) after security activation. A broadcast control channel (BCCH) logical channel may be used for broadcasting system information. Some of BCCH logical channel may convey system information which may be sent from the network to the UE via BCH (Broadcast Channel) transport channel. BCH may be sent on a physical broadcast channel (PBCH). Some of BCCH logical channel may convey system information which may be sent from the network to the UE via DL-SCH (Downlink Shared Channel) transport channel. Paging may be provided by using paging control channel (PCCH) logical channel.

System information may be divided into the MasterInformationBlock (MIB) and a number of SystemInformationBlocks (SIBs).

The UE may receive one or more RRC messages from the base station to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The base station may transmit one or more RRC messages to the UE to cause the UE to configure RRC layer and/or lower layers of the UE according to the RRC configurations or parameters which may be configured by the RRC messages, broadcasted system information, and so on.

The size of various fields in the time domain is expressed in time units T_{c}=1/(Δfₘₐₓ×N_{f}) where Δfₘₐₓ=480×10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

Multiple OFDM numerologies are supported as given by Table 4.2-1 of [TS 38.211] where μ and the cyclic prefix for a bandwidth part are obtained from the higher-layer parameter subcarrierSpacing and cyclicPrefix, respectively.

The size of various fields in the time domain may be expressed as a number of time units T_{c}=1/(15000×2048) seconds. Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is

$${N}_{symb}^{subframe , μ} = {N}_{symb}^{slot} {N}_{slot}^{subframe , μ} .$$

Each frame is divided into two equally-sized half-frames of five subframes each with half-frame 0 consisting of subframes 0-4 and half-frame 1 consisting of subframes 5-9.

For subcarrier spacing (SCS) configuration μ, slots are numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{frame , μ} - 1 \}$$

in increasing order within a frame.

$${N}_{slot}^{subframe , μ}$$

is the number of slots per subframe for subcarrier spacing configuration μ. There are

$${N}_{symb}^{slot}$$

consecutive OFDM symbols in a slot where

$${N}_{symb}^{slot}$$

depends on the cyclic prefix as given by Tables 4.3.2-1 and 4.3.2-2 of [TS 38.211]. The start of slot

$${n}_{s}^{μ}$$

in a subframe is aligned in time with the start of OFDM symbol

$${n}_{s}^{μ} {N}_{symb}^{slot}$$

in the same subframe. Subcarrier spacing refers to a spacing (or frequency bandwidth) between two consecutive subcarriers in the frequency domain. For example, the subcarrier spacing can be set to 15 kHz (i.e. μ=0), 30 kHz (i.e. μ=1), 60 kHz (i.e. μ=2), 120 kHz (i.e. μ=3), or 240 kHz (i.e. μ=4). A resource block is defined as a number of consecutive subcarriers (e.g. 12) in the frequency domain. For a carrier with different frequency, the applicable subcarrier may be different. For example, for a carrier in a frequency rang 1, a subcarrier spacing only among a set of {15 kHz, 30 kHz, 60 kHz} is applicable. For a carrier in a frequency rang 2, a subcarrier spacing only among a set of {60 kHz, 120 kHz, 240 kHz} is applicable. The base station may not configure an inapplicable subcarrier spacing for a carrier.

OFDM symbols in a slot can be classified as ‘downlink’, ‘flexible’, or ‘uplink’. Signaling of slot formats is described in subclause 11.1 of [TS 38.213].

In a slot in a downlink frame, the UE may assume that downlink transmissions only occur in ‘downlink’ or ‘flexible’ symbols. In a slot in an uplink frame, the UE may only transmit in ‘uplink’ or ‘flexible’ symbols.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

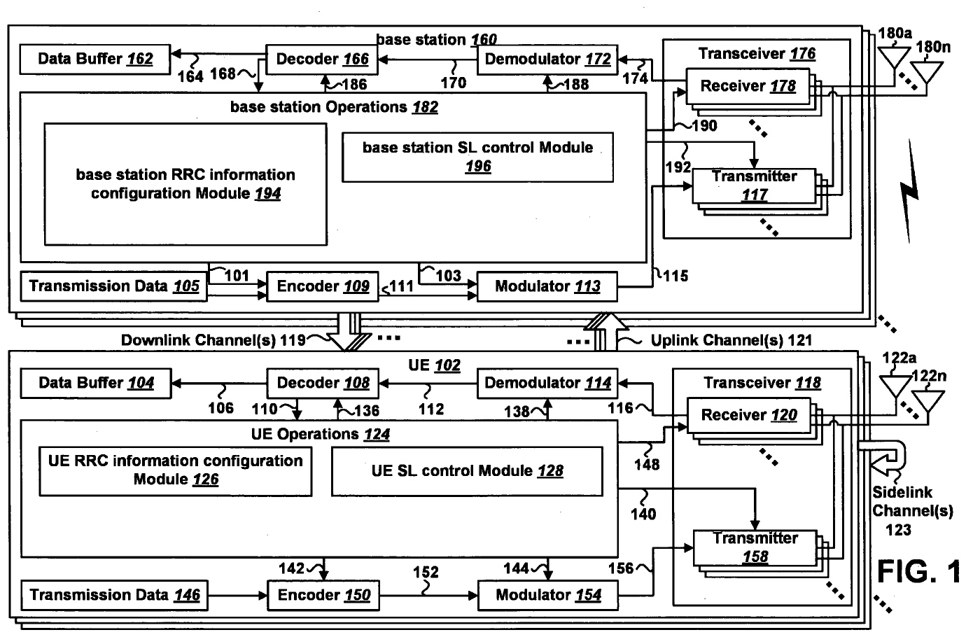

FIG. 1 is a block diagram illustrating one configuration of one or more base stations 160 (e.g., eNB, gNB) and one or more user equipments (UEs) 102 in which systems and methods for determination of PSFCH resources may be implemented. The one or more UEs 102 may communicate with one or more base stations 160 using one or more antennas 122a-n. For example, a UE 102 transmits electromagnetic signals to the base station 160 and receives electromagnetic signals from the base station 160 using the one or more antennas 122a-n. The base station 160 communicates with the UE 102 using one or more antennas 180a-n. Additionally, one or more UEs 102 may communicate with one or more UEs 102 using one or more antennas 122a-n. For example, a UE 102 transmits electromagnetic signals to another UE(s) 102 and receives electromagnetic signals from another UE(s) 102 using the one or more antennas 122a-n. That is, one or more UEs communicate with each other via sidelink communication.

The UEs 102 may directly communicate with each other by using the sidelink communication. For illustration, UE(s) 102 capable of sidelink communication include a UE 1A, a UE 1B and a UE 1C. The UE 1A may be located within the coverage of the base station 160. The UE 1B and the UE 1C may be located outside the coverage of the base station 160. The UE 1A and the base station 160 may communicate with each other via downlink and uplink communication. In addition, the UE 1A and the UE 1B may directly communicate with each other via sidelink communication. In addition, the UE 1B and the UE 1C may directly communicate with each other via sidelink communication.

It should be noted that in some configurations, one or more of the UEs 102 described herein may be implemented in a single device. For example, multiple UEs 102 may be combined into a single device in some implementations. Additionally or alternatively, in some configurations, one or more of the base stations 160 described herein may be implemented in a single device. For example, multiple base stations 160 may be combined into a single device in some implementations. In the context of FIG. 1, for instance, a single device may include one or more UEs 102 in accordance with the systems and methods described herein. Additionally or alternatively, one or more base stations 160 in accordance with the systems and methods described herein may be implemented as a single device or multiple devices.

The UE 102 and the base station 160 may use one or more channels 119, 121 to communicate with each other. For example, a UE 102 may transmit information or data to the base station 160 using one or more uplink (UL) channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more base stations 160 may also transmit information or data to the one or more UEs 102 using one or more downlink (DL) channels 119 and signals, for instance. Examples of downlink channels 119 include a PDCCH, a PDSCH, etc. A PDCCH can be used to schedule DL transmissions on PDSCH and UL transmissions on PUSCH, where the Downlink Control Information (DCI) on PDCCH includes downlink assignment and uplink scheduling grants. A PDCCH can be also used for scheduling of sidelink transmissions on PSCCH and PSSCH in one cell, where the Downlink Control Information (DCI) on PDCCH includes sidelink scheduling grants. The PDCCH is used for transmitting Downlink Control Information (DCI) in a case of downlink radio communication (radio communication from the base station to the UE). Here, one or more DCIs (may be referred to as DCI formats) are defined for transmission of downlink control information. Information bits are mapped to one or more fields defined in a DCI format. Examples of downlink signals include a primary synchronization signal (PSS), a secondary synchronization signal (SSS), a cell-specific reference signal (CRS), a non-zero power channel state information reference signal (NZP CSI-RS), and a zero power channel state information reference signal (ZP CSI-RS), etc. Other kinds of channels or signals may be used.

For the UE(s) 102 capable of sidelink communication, the UEs 102 may use one or more sidelink channels 123 to communicate with each other. For example, a UE 102 may transmit information or data to another UE 102 using one or more sidelink (SL) channels 123 and signals. Examples of sidelink channels 123 include a physical sidelink control channel (PSCCH), a physical sidelink shared channel (PSSCH), a physical sidelink feedback channel (PSFCH), and a physical sidelink broadcast channel (PSBCH). Examples of sidelink signals include a demodulation reference signal (DMRS), a phase-tracking reference signal (PT-RS), a channel-state information reference signal (CSI-RS), a sidelink primary synchronization signal (S-PSS), and a sidelink secondary synchronization signal (S-SSS).

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals, sidelink channels, sidelink signals) from the base station 160 or from another UE 102 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals, sidelink channels, sidelink signals) to the base station 160 or to another UE 102 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more base stations 160. For a UE capable of sidelink communication, the UE operations module 124 may enable the UE 102 to communicate with the one or more other UE. The UE operations module 124 may include a UE RRC information configuration module 126. For a UE capable of sidelink communication, the UE operations module 124 may include a UE sidelink (SL) control module 128. In some implementations, the UE operations module 124 may include physical (PHY) entities, Medium Access Control (MAC) entities, Radio Link Control (RLC) entities, packet data convergence protocol (PDCP) entities, and a Radio Resource Control (RRC) entity. For example, the UE RRC information configuration module 126 may process RRC parameter for random access configurations, initial UL BWP configuration, maximum bandwidth the UE can support, and cell specific PUCCH resource configuration(s).

For a UE capable of sidelink transmission, the UE RRC information configuration module 126 may process parameters included in the (pre-)configuration(s) related to sidelink communications. The UE RRC information configuration module 126 may include a memory unit to store the (pre-)configuration(s) related to sidelink communications. For example, the UE RRC information configuration module 126 may, based on the parameters, determine a SL BWPs, one or more resource pools within the SL BWP in frequency domain and time domain for SL communications. The UE SL control module 128 may determine the frequency resources, the time resources and/or the code resources for transmission or reception of the PSCCH, the PSSCH and/or the PSFCH. The frequency resources for transmission or reception of the PSCCH, the PSSCH and the PSFCH include information related to assigned interlace(s) and RB set(s).

The UE SL control module 128 may determine sub-channels over the unlicensed spectrum. The UE SL control module (processing module) 128 may determine which one or more interlaces of M interlaces are included in a sub-channel based on a first parameter and a second parameter. The first parameter indicates an RB index with respect to a lowest RB index of the SL BWP and the second parameter indicates a number of interlaces, K, included in a sub-channel in a resource pool.

The UE RRC information configuration module 126 may provide information related to frequency resources, time resources and/or code resources of PSFCH to the UE SL control module 128. The UE SL control module 128 may determine a set of PSFCH resources that are available for a PSFCH transmission with HARQ-ACK information in response to a given PSSCH reception. The UE RRC information configuration module 126 may determine to index each PSFCH resources in the set according to its RB set index, its interlace index, and its cyclic shift pair index.

Additionally, the UE RRC information configuration module 126 may provide a parameter, which indicates a first number of cyclic shift pairs for a resource pool, to the UE SL control module 128. The first number cyclic shift pairs correspond to their respective the first number initial cyclic shift values. The UE SL control module 128 may determine, based on the value of the first number, a sequence cyclic shift value for a sequence used for a PSFCH transmission from a set B of four sequence cyclic shift values or a set C of four sequence cyclic shift values.

The UE operations module 124 may provide information 148 to the one or more receivers 120. For example, the UE operations module 124 may inform the receiver(s) 120 when or when not to receive transmissions based on the Radio Resource Control (RRC) message (e.g., broadcasted system information, RRC reconfiguration message), MAC control element, SCI (Sidelink Control Information) and/or the DCI (Downlink Control Information). The UE operations module 124 may provide information 148, including the PDCCH monitoring occasions, DCI format size, PSCCH monitoring occasions and SCI format size, to the one or more receivers 120. The UE operation module 124 may inform the receiver(s) 120 when or where to receive/monitor the PDCCH candidate for DCI formats and/or the PSCCH candidate for SCI formats.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160. For example, the UE operations module 124 may inform the decoder 108 of an anticipated PDCCH candidate encoding with which DCI size for transmissions from the base station 160. The UE operations module 124 may inform the decoder 108 of an anticipated PSCCH candidate encoding with which SCI size for transmissions from another UE 102.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160 or another UE 102. The one or more transmitters 158 may upconvert and transmit the modulated signal(s) 156 to one or more base stations 160 or another one or more UEs 102.

The base station 160 may include one or more transceivers 176, one or more demodulators 172, one or more decoders 166, one or more encoders 109, one or more modulators 113, one or more data buffers 162 and one or more base station operations modules 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first base station-decoded signal 164 may comprise received payload data, which may be stored in a data buffer 162. A second base station-decoded signal 168 may comprise overhead data and/or control data. For example, the second base station-decoded signal 168 may provide data (e.g., PUSCH transmission data) that may be used by the base station operations module 182 to perform one or more operations.

In general, the base station operations module 182 may enable the base station 160 to communicate with the one or more UEs 102. For a base station capable of sidelink communication, the UE operations module 124 may enable the base station 160 to communicate with the one or more UEs 102 capable of sidelink communication. The base station operations module 182 may include a base station RRC information configuration module 194. For a base station capable of sidelink communication, the base station operations module 182 may include a base station sidelink (SL) control module 196 (or a base station SL processing module 196). The base station operations module 182 may include PHY entities, MAC entities, RLC entities, PDCP entities, and an RRC entity.

For a base station capable of sidelink transmission, the base station SL control module 196 may determine, for respective UE, the time and frequency resource for scheduling PSCCH and PSSCH and input the information to the base station RRC information configuration module 194. The base station RRC information configuration module 194 may determine whether to generate the third parameter in a SL resource pool configuration. The base station RRC information configuration module 194 may provide information of the third parameter to the base station SL control module 196. The base station SL control module 196 may determine a size of a frequency resource assignment included in the DCI format 3_0 based on whether the base station RRC information configuration module 194 generates the third parameter in the SL resource pool configuration or not.

The base station SL control module 196 may generate a DCI format 3_0 to indicate frequency and time resources of PSSCH to a UE 102. The base station SL control module 196 may generate a DCI format 3_0 to indicate frequency and time resources of PSSCH to a UE 102.

The base station operations module 182 may provide the benefit of performing PDCCH candidate search and monitoring efficiently. The base station operations module 182 may provide information 190 to the one or more receivers 178. For example, the base station operations module 182 may inform the receiver(s) 178 when or when not to receive transmissions based on the RRC message (e.g., broadcasted system information, RRC reconfiguration message), MAC control element, and/or the DCI (Downlink Control Information).

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode transmission data 105 and/or other information 101.

In general, the base station operations module 182 may enable the base station 160 to communicate with one or more network nodes (e.g., a NG mobility management function, a NG core UP functions, a mobility management entity (MME), serving gateway (S-GW), gNBs). The base station operations module 182 may also generate a RRC reconfiguration message to be signaled to the UE 102.

The encoder 109 may encode transmission data 105 and/or other information 101 provided by the base station operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The base station operations module 182 may provide information 192, including the PDCCH monitoring occasions and DCI format size, to the one or more transmitters 117. The base station operation module 182 may inform the transmitter(s) 117 when or where to transmit the PDCCH candidate for DCI formats with which DCI size. The one or more transmitters 117 may upconvert and transmit the modulated signal(s) 115 to one or more UEs 102.

It should be noted that one or more of the elements or parts thereof included in the base station(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

A base station may generate a RRC message including the one or more RRC parameters, and may transmit the RRC message to a UE. A UE may receive, from a base station, a RRC message including one or more RRC parameters. The term ‘RRC parameter(s)’ in the present disclosure may be alternatively referred to as ‘RRC information element(s)’. A RRC parameter may further include one or more RRC parameter(s). In the present disclosure, a RRC message may include system information. a RRC message may include one or more RRC parameters. A RRC message may be sent on a broadcast control channel (BCCH) logical channel, a common control channel (CCCH) logical channel or a dedicated control channel (DCCH) logical channel.

In the present disclosure, a description ‘a base station may configure a UE to’ may also imply/refer to ‘a base station may transmit, to a UE, an RRC message including one or more RRC parameters’. Additionally or alternatively, ‘RRC parameter configure a UE to’ may also refer to ‘a base station may transmit, to a UE, an RRC message including one or more RRC parameters’. Additionally or alternatively, ‘a UE is configured to’ may also refer to ‘a UE may receive, from a base station, an RRC message including one or more RRC parameters’.

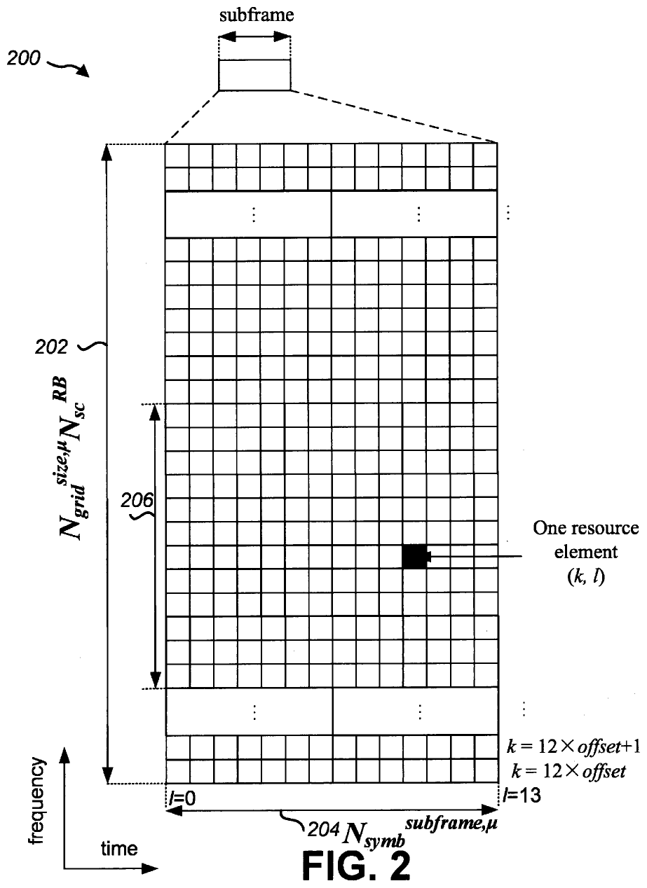

FIG. 2 is a diagram illustrating one example of a resource grid 200.

For each numerology and carrier, a resource grid of N_{grid,x}^{size,μ}N_{sc}^{RB} subcarriers and N_{symb}^{subframe,μ} OFDM symbols is defined, starting at common resource block N_{grid}^{start,μ} indicated by higher layer signaling. There is one set of resource grids per transmission direction (uplink or downlink) with the subscript x set to DL and UL for downlink and uplink, respectively. There is one resource grid for a given antenna port p, subcarrier spacing configuration u, and the transmission direction (downlink or uplink). When there is no risk for confusion, the subscript x may be dropped.

In the FIG. 2, the resource gird 200 includes the N_{grid,x}^{size,μ}N_{sc}^{RB} (202) subcarriers in the frequency domain and includes N_{symb}^{subframe,μ} (204) symbols in the time domain. In the FIG. 2, as an example for illustration, the subcarrier spacing configuration μ is set to 0. That is, in the FIG. 2, the number of consecutive OFDM symbols N_{symb}^{subframe,μ} (204) per subframe is equal to 14.

The carrier bandwidth N_{grid}^{size,μ} (N_{grid,x}^{size,μ}) for subcarrier spacing configuration μ is given by the higher-layer (RRC) parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE. The frequency location of a subcarrier refers to the center frequency of that subcarrier.

In the FIG. 2, for example, a value of offset is provided by the higher-layer parameter offsetToCarrier. That is, k=12×offset is the lowest usable subcarrier on this carrier.

Each element in the resource grid for antenna port p and subcarrier spacing configuration μ is called a resource element and is uniquely identified by (k, l)_{p,μ} where k is the index in the frequency domain and l refers to the symbols position in the time domain relative to same reference point. The resource element consists of one subcarrier during one OFDM symbol.

A resource block is defined as N_{sc}^{RB}=12 consecutive subcarriers in the frequency domain. As shown in the FIG. 2, a resource block 206 includes 12 consecutive subcarriers in the frequency domain. Resource block can be classified as common resource block (CRB) and physical resource block (PRB).

Common resource blocks are numbered from 0 and upwards in the frequency domain for subcarrier spacing configuration μ. The center of subcarrier 0 of common resource block with index 0 (i.e. CRB0) for subcarrier spacing configuration μ coincides with point A. The relation between the common resource block number

$${n}_{CRB}^{μ}$$

in the frequency domain and resource element (k, l) for subcarrier spacing configuration μ is given by Formula (1) n_{CRB}^{μ}=floor(k/N_{sc}^{RB}) where k is defined relative to the point A such that k=0 corresponds to the subcarrier centered around the point A. The function floor(A) hereinafter is floor operation to output a maximum integer not larger than the A.

Point A refers to as a common reference point. Point A coincides with subcarrier 0 (i.e., k=0) of a CRB 0 for all subcarrier spacing. Point A can be obtained from a RRC parameter offsetToPointA or a RRC parameter absoluteFrequencyPointA. The RRC parameter offsetToPointA is used for a PCell downlink and represents the frequency offset between point A and the lowest subcarrier of the lowest resource block, which has the subcarrier spacing provided by a higher-layer parameter subCarrierSpacingCommon and overlaps with the SS/PBCH block used by the UE for initial cell selection, expressed in units of resource blocks assuming 15 kHz subcarrier spacing for frequency range (FR) 1 and 60 kHz subcarrier spacing for frequency range (FR2). FR1 corresponds to a frequency range between 410 MHz and 7125 MHz. FR2 corresponds to a frequency range between 24250 MHz and 52600 MHz. The RRC parameter absoluteFrequencyPointA is used for all cased other than the PCell case and represents the frequency-location of point A expressed as in ARFCN. The frequency location of point A can be the lowest subcarrier of the carrier bandwidth (or the actual carrier). Additionally, point A may be located outside the carrier bandwidth (or the actual carrier).

As above mentioned, the information element (IE) SCS-SpecificCarrier provides parameters determining the location and width of the carrier bandwidth or the actual carrier. That is, a carrier (or a carrier bandwidth, or an actual carrier) is determined (identified, or defined) at least by a RRC parameter offsetToCarrier, a RRC parameter subcarrierSpacing, and a RRC parameter carrierBandwidth in the SCS-SpecificCarrier IE.

The subcarrierSpacing indicates (or defines) a subcarrier spacing of the carrier. The offsetToCarrier indicates an offset in frequency domain between point A and a lowest usable subcarrier on this carrier in number of resource blocks (e.g. CRBs) using the subcarrier spacing defined for the carrier. The carrierBandwidth indicates width of this carrier in number of resource blocks (e.g. CRBs or PRBs) using the subcarrier spacing defined for the carrier. A carrier includes at most 275 resource blocks.

Physical resource blocks for subcarrier spacing configuration u are defined within a bandwidth part and numbered form 0 to N_{BWP,i}^{size,μ} where i is the number of the bandwidth part. The relation between the physical resource block n_{PRB}^{μ} in bandwidth part (BWP) i and the common resource block n_{CRB}^{μ} is given by Formula (2) n_{CRB}^{μ}=n_{PRB}^{μ}+N_{BWP,i}^{start, μ} where N_{BWP,i}^{start,μ} is the common resource block where bandwidth part i starts relative to common resource block 0 (CRB0). When there is no risk for confusion the index μ may be dropped.

A BWP is a subset of contiguous common resource block for a given subcarrier spacing configuration u on a given carrier. To be specific, a BWP can be identified (or defined) at least by a subcarrier spacing u indicated by the RRC parameter subcarrierSpacing, a cyclic prefix determined by the RRC parameter cyclicPrefix, a frequency domain location, a bandwidth, an BWP index indicated by bwp-Id and so on. The locationAndBandwidth can be used to indicate the frequency domain location and bandwidth of a BWP. The value indicated by the locationAndBandwidth is interpreted as resource indicator value (RIV) corresponding to an offset (a starting resource block) RBₛₜₐᵣₜ and a length L_{RB} in terms of contiguously resource blocks. The offset RBₛₜₐᵣₜ is a number of CRBs between the lowest CRB of the carrier and the lowest CRB of the BWP. The N_{BWP,i}^{start,μ} is given as Formula (3) N_{BWP,i}^{start, μ}=O_{carrier}+RBₛₜₐᵣₜ. The value of O_{carrier} is provided by offsetTocarrier for the corresponding subcarrier spacing configuration μ.

A UE 102 configured to operate in BWPs of a serving cell, is configured by higher layers for the serving cell a set of at most four BWPs in the downlink for reception. At a given time, a single downlink BWP is active. The bases station 160 may not transmit, to the UE 102, PDSCH and/or PDCCH outside the active downlink BWP. A UE 102 configured to operate in BWPs of a serving cell, is configured by higher layers for the serving cell a set of at most four BWPs for transmission. At a given time, a single uplink BWP is active. The UE 102 may not transmit, to the base station 160, PUSCH or PUCCH outside the active BWP. The specific signaling (higher layers signaling) for BWP configurations are described later.

A UE 102, configured to operate in a SL BWP, is configured or preconfigured by higher layers for the serving cell or by a pre-configuration a SL BWP for sidelink reception and/or transmission. At a given time, a single SL BWP is active. The UE 102 may not transmit, to another UE 102, sidelink channel (PSCCH, PSCCH, and/or PSFCH) outside the active SL BWP.

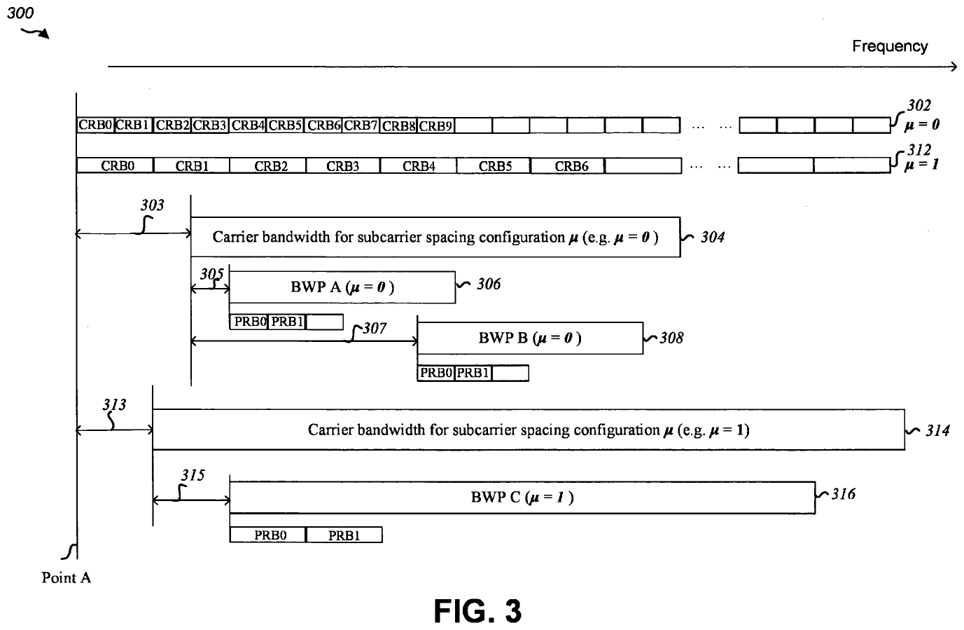

FIG. 3 is a diagram illustrating one example 300 of common resource block grid, carrier configuration and BWP configuration by a UE 102 and a base station 160.

Point A 301 is a lowest subcarrier of a CRB0 for all subcarrier spacing configurations. The CRB grid 302 and the CRB grid 312 are corresponding to two different subcarrier spacing configurations. The CRB grid 302 is for subcarrier spacing configuration μ=0 (i.e. the subcarrier spacing with 15 kHz). The CRB grid 312 is for subcarrier spacing configuration μ=1 (i.e., the subcarrier spacing with 30 kHz).

One or more carriers are determined by respective SCS-SpecificCarrier IEs, respectively. In the FIG. 3, the carrier 304 uses the subcarrier spacing configuration μ=0. And the carrier 314 uses the subcarrier spacing configuration μ=1. The starting position N_{grid}^{start,μ} of the carrier 304 is given based on the value of an offset 303 (i.e. O_{carrier}) indicated by an offsetToCarrier in an SCS-SpecificCarrier IE. As shown in the FIG. 3, for example, the offsetToCarrier indicates the value of the offset 303 as O_{carrier}=3. That is, the starting position N_{grid}^{start,μ} of the carrier 304 corresponds to the CRB3 of the CRB grid 302 for subcarrier spacing configuration μ=0. In the meantime, the starting position N_{grid}^{start,μ} of the carrier 314 is given based on the value of an offset 313 (i.e. O_{carrier}) indicated by an offsetToCarrier in another SCS-SpecificCarrier IE. For example, the offsetToCarrier indicates the value of the offset 313 as O_{carrier}=1. That is, the starting position N_{grid}^{start,μ} of the carrier 314 corresponds to the CRB1 of the CRB grid 312 for subcarrier spacing configuration μ=1. A carrier using different subcarrier spacing configurations can occupy different frequency ranges.

As above-mentioned, a BWP is for a given subcarrier spacing configuration μ. One or more BWPs can be configured for a same subcarrier spacing configuration u. For example, in the FIG. 3, the BWP 306 is identified at least by the μ=0, a frequency domain location, a bandwidth (L_{RB}), and an BWP index (index A). The first PRB (i.e. PRB0) of a BWP is determined at least by the subcarrier spacing of the BWP, an offset derived by the locationAndBandwidth and an offset indicated by the offsetToCarrier corresponding to the subcarrier spacing of the BWP. An offset 305 (RBₛₜₐᵣₜ) is derived as 1 by the locationAndBandwidth. According to the Formulas (2) and (3), the PRB0 of BWP 306 corresponds to CRB 4 of the CRB grid 302, and the PRB1 of BWP 306 corresponds to CRB 5 of the CRB grid 302, and so on.

Additionally, in the FIG. 3, the BWP 308 is identified at least by the μ=0, a frequency domain location, a bandwidth (L_{RB}), and an BWP index (index B). For example, an offset 307 (RBₛₜₐᵣₜ) is derived as 6 by the locationAndBandwidth. According to the Formulas (2) and (3), the PRB0 of BWP 308 corresponds to CRB 9 of the CRB grid 302, and the PRB1 of BWP 308 corresponds to CRB 10 of the CRB grid 302, and so on.

Additionally, in the FIG. 3, the BWP 316 is identified at least by the μ=1, a frequency domain location, a bandwidth (L_{RB}), and an BWP index (index C). For example, an offset 315 (RBₛₜₐᵣₜ) is derived as 1 by the locationAndBandwidth. According to the Formulas (2) and (3), the PRB0 of BWP 316 corresponds to CRB 2 of the CRB grid 312, and the PRB1 of BWP 316 corresponds to CRB 3 of the CRB grid 312, and so on.

In the present disclosure, a BWP illustrated in the FIG. 3 may refer to a DL BWP, a UL BWP, or a sidelink BWP.

As shown in the FIG. 3, a carrier with the defined subcarrier spacing locate in a corresponding CRB grid with the same subcarrier spacing. A BWP with the defined subcarrier spacing locate in a corresponding CRB grid with the same subcarrier spacing as well.

A base station may transmit a RRC message including one or more RRC parameters related to BWP configuration to a UE. A UE may receive the RRC message including one or more RRC parameters related to BWP configuration from a base station. For each cell, the base station may configure at least an initial DL BWP, one initial uplink bandwidth parts (initial UL BWP) and one sidelink BWP to the UE. Furthermore, the base station may configure additional UL and DL BWPs to the UE for a cell.

SIB1, which is a cell-specific system information block (SystemInformationBlock, SIB), may contain information relevant when evaluating if a UE is allowed to access a cell and define the scheduling of other system information. SIB1 may also contain radio resource configuration information that is common for all UEs and barring information applied to the unified access control. The RRC parameter ServingCellConfigCommon is used to configure cell specific parameters of a UE's serving cell. The RRC parameter ServingCellConfig is used to configure (add or modify) the UE with a serving cell, which may be the SpCell or an SCell of an MCS or SCG. The RRC parameter ServingCellConfig herein are mostly UE specific but partly also cell specific.

The base station may configure the UE with a RRC parameter BWP-Downlink and a RRC parameter BWP-Uplink. The RRC parameter BWP-Downlink can be used to configure an additional DL BWP. The RRC parameter BWP-Uplink can be used to configure an additional UL BWP. The base station may transmit the BWP-Downlink and the BWP-Uplink which may be included in RRC parameter ServingCellConfig to the UE.

The UE may be configured by the based station, at least one initial BWP and up to 4 additional BWP(s). One of the initial BWP and the configured additional BWP(s) may be activated as an active BWP. The UE may monitor DCI format, and/or receive PDSCH in the active DL BWP. The UE may not monitor DCI format, and/or receive PDSCH in a DL BWP other than the active DL BWP. The UE may transmit PUSCH and/or PUCCH in the active UL BWP. The UE may not transmit PUSCH and/or PUCCH in a BWP other than the active UL BWP.

As above-mentioned, a UE may monitor DCI format in the active DL BWP. To be more specific, a UE may monitor a set of PDCCH candidates in one or more CORESETs on the active DL BWP on each activated serving cell configured with PDCCH monitoring according to corresponding search space set where monitoring implies decoding each PDCCH candidate according to the monitored DCI formats.

A set of PDCCH candidates for a UE to monitor is defined in terms of PDCCH search space sets. A search space set can be a CSS set or a USS set. A UE may monitor a set of PDCCH candidates in one or more of the search space sets.

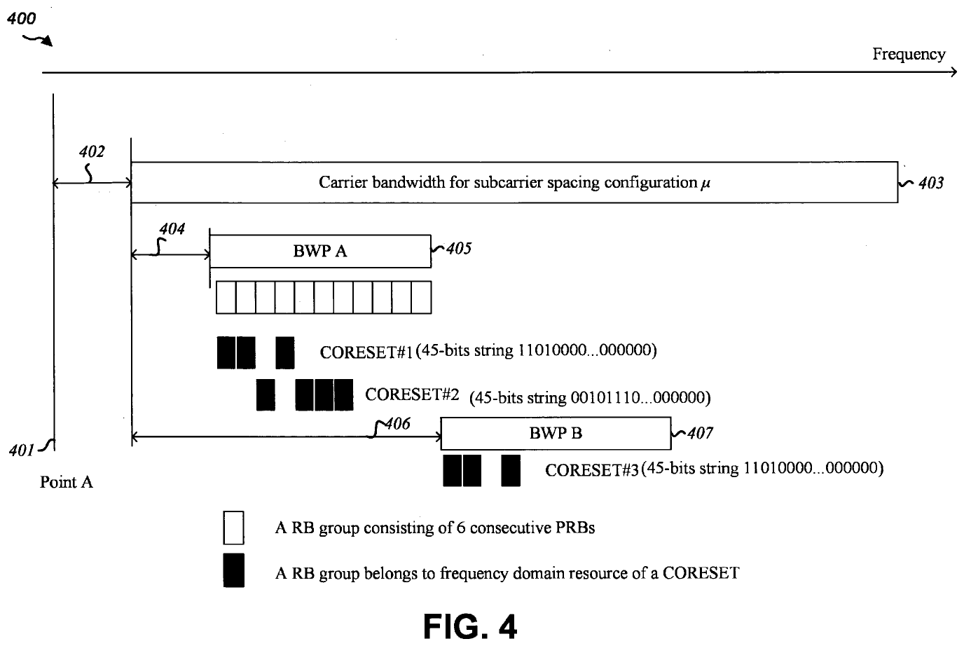

FIG. 4 is a diagram illustrating one 400 example of CORESET configuration in a BWP by a UE 102 and a base station 160.

FIG. 4 illustrates that a UE 102 is configured with three CORESETs for receiving PDCCH transmission in two BWPs. In the FIG. 4, 401 represent point A. 402 is an offset in frequency domain between point A 401 and a lowest usable subcarrier on the carrier 403 in number of CRBs, and the offset 402 is given by the offsetToCarrier in the SCS-SpecificCarrier IE. The BWP 405 with index A and the carrier 403 are for a same subcarrier spacing configuration u. The offset 404 between the lowest CRB of the carrier and the lowest CRB of the BWP in number of RBs is given by the locationAndBandwidth included in the BWP configuration for BWP A. The BWP 407 with index B and the carrier 403 are for a same subcarrier spacing configuration μ. The offset 406 between the lowest CRB of the carrier and the lowest CRB of the BWP in number of RBs is given by the locationAndBandwidth included in the BWP configuration for BWP B.

For the BWP 405, two CORESETs are configured. As above-mentioned, a RRC parameter frequencyDomainResource in respective CORESET configuration indicates the frequency domain resource for respective CORESET. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #1. That is, the first RB group, the second RB group, and the fourth RB group belong to the frequency domain resource of the CORESET #1. Additionally, the RRC parameter frequencyDomainResource provides a bit string with a fixed size (e.g. 45 bits) as like ‘00101110 . . . 000000’ for CORESET #2. That is, the third RB group, the fifth RB group, the sixth RB group and the seventh RB group belong to the frequency domain resource of the CORESET #2.

For the BWP 407, one CORESET is configured. As above-mentioned, a RRC parameter frequencyDomainResource in the CORESET configuration indicates the frequency domain resource for the CORESET #3. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #3. That is, the first RB group, the second RB group, and the fourth RB group belong to the frequency domain resource of the CORESET #3. Although the bit string configured for CORESET #3 is same as that for CORESET #1, the first RB group of the BWP B is different from that of the BWP A in the carrier. Therefore, the frequency domain resource of the CORESET #3 in the carrier is different from that of the CORESET #1 as well.

For the communication system, spectrum is divided into licensed spectrum and unlicensed spectrum. The NR technologies have been developed in the licensed spectrum and in the unlicensed spectrum. The operation in unlicensed spectrum, used as a complementary solution, can increase the throughput of the overall wireless communication system. However, operation in unlicensed spectrum is subject to regulatory limitations and restrictions. For example, the European Telecommunications Standards Institute (ETSI) has defined regulations for operation over the unlicensed spectrum. For example, the occupied channel bandwidth (OCB), which is defined as a bandwidth containing 99% of the signal power, should be larger than a percentage of the nominal channel bandwidth (NCB). For example, according to the ETSI regulations, the OCB should be between 70% and 100% of the NCB for 5 GHz band.

An unlicensed band (or a carrier, or a subband) would be divided into one or multiple non-overlapping channels of 20 MHz bandwidth in the frequency domain. For a (nominal) channel bandwidth of 20 MHz, one transmission should occupy a channel bandwidth larger than what the regulation on OCB requires, for example, one transmission should be larger than 80% of the channel bandwidth of 20 MHz to meet the OCB requirement. To meet the OCB requirement, the design of interlaced transmission had been introduced where each interlace transmission within a channel bandwidth can occupy a channel bandwidth being larger than what the OCB requires.

Interlaced transmission had been introduced to ensure the compliance with the regulations on OCB and NCB requirements. Specifically, the interlaced transmission is designed such that each interlace can occupy the channel bandwidth where the occupied channel bandwidth can fulfill the requirement of the OCB.

An interlace includes a set of resource blocks that are spread out across the bandwidth of a carrier in the frequency domain. A number of interlaces M is subject to the value of a SCS. That is, the number of interlaces M may be predefined according to a specific SCS. For example, if the SCS is equal to 15 kHz, the number of resource block interlaces M is correspondingly equal to 10. If the SCS is equal to 30 kHz, the number of resource block interlaces M is correspondingly equal to 5.

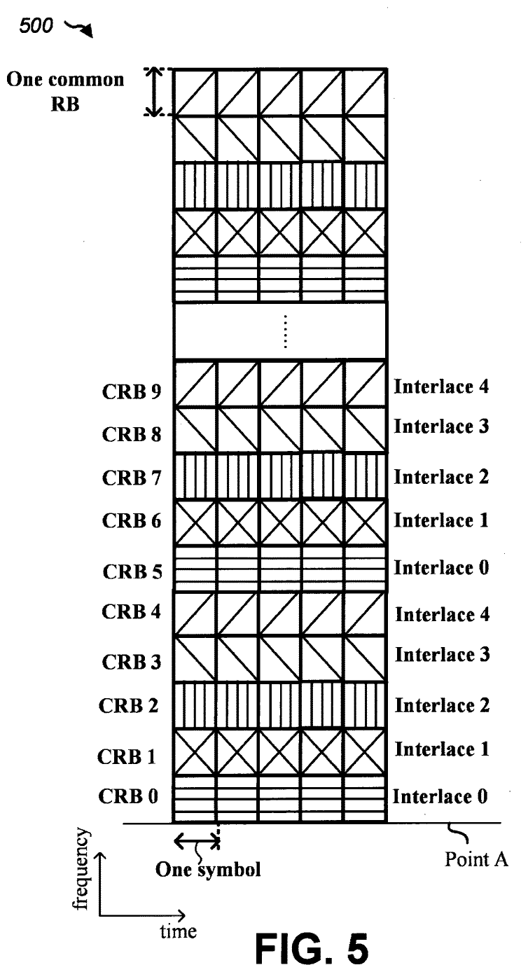

FIG. 5 is a diagram illustrating one example 500 for interlaced resource blocks for transmission and reception. In the FIG. 5, each block in the frequency domain refers to a common resource block. In the FIG. 5, the subcarrier spacing is configured as 30 kHz and the number of resource block interlaces, which is denoted as M, are 5. Then the interlaces are indexed from 0 to M−1. That is, an interlace m, where m=0, 1, . . . , M−1, consists of a plurality of common resource blocks with indexes {m, M+m, 2M+m, 3M+m, . . . }. For example, in the FIG. 5, the interlace m=0 consists of common resource blocks with indexes {0, 5, 10, 15, . . . }, the interlace m=1 consists of common resource blocks with indexes {1, 6, 11, 16, . . . }, and so on.

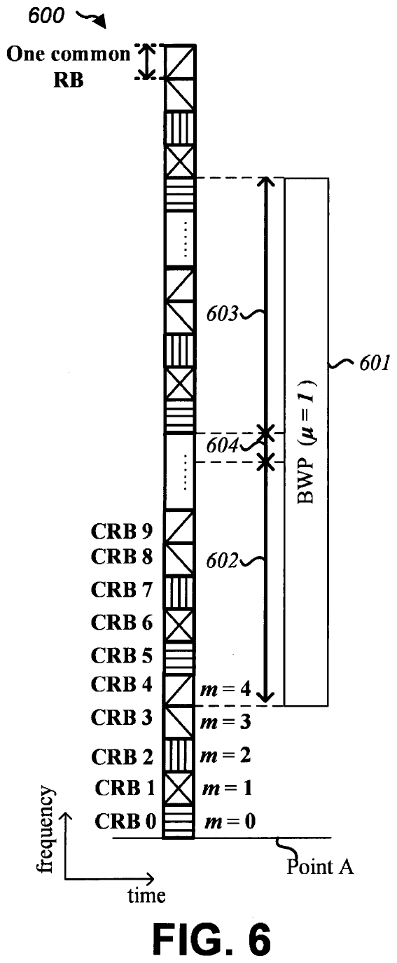

FIG. 6 is a diagram illustrating one example 600 of interlaced mapping for a BWP. In the FIG. 6, the subcarrier spacing is configured as 30 kHz and the number of resource block interlaces M are 5. In the frequency domain, a BWP 601 is determined as illustrated in FIG. 3.

An interlaced resource block in the BWP is denoted as

$${n}_{IRB , m}^{μ}$$

where the

$${n}_{IRB , m}^{μ}$$

is indexed from 0, 1, . . . , in the BWP. The relation between the interlace resource block

$${n}_{IRB , m}^{μ}$$

the interlace m and the common resource block

$${n}_{CRB}^{μ}$$

is given by

$${n}_{CRB}^{μ} = {Mn}_{IRB , m}^{μ} + {N}_{BWP}^{start , μ} + ( ( m - {N}_{BWP}^{start , μ} ) mod M ) . The {N}_{BWP}^{start , μ}$$

is the common resource block where the BWP starts relative to common resource block 0 (i.e., a common resource block with index 0). In the FIG. 6, the BWP 601 starts in a CRB with index 4 relative to the CRB with index 0.

At least for NR-U operation in, for example, 5 GHz spectrum, a BWP may have a bandwidth of multiple of 20 MHz. A sub-band may comprise 20 MHz or a multiple of 20 MHz bandwidth. A sub-band may also be referred to as a sub-channel, or a channel access bandwidth (e.g., a channel of 20 MHz). Then a BWP may include one or more sub-bands in the frequency domain. A sub-band consists of multiple non-overlapping RBs. The number of resource blocks within a sub-band may depend on the SCS of the BWP. For example, the sub-band size for SCS=15 kHz may be equal to 108 for a 40 MHz BWP, and the sub-band size for SCS=30 kHz may be equal to 53 for a 40 MHz BWP. That is, a sub-band is an RB set of non-overlapping and contiguous (common) resource blocks. And a sub-band can be defined by a starting common RB and an ending common RB in the frequency domain. Hereinafter, an RB set is used to refer to a sub-band. In other words, an RB set consists of non-overlapping resource blocks and can be defined by a starting common RB and an ending common RB.

As in the FIG. 6, the BWP 601 includes two RB sets, i.e., a RB set 602 and a RB set 603. The RB sets within a BWP can be indexed from 0 in an increase order along with the frequency. According to higher layer (RRC) configurations, there may be a gap 604 between two consecutive RB set. The gap in unit of resource block can be indicated by the higher layer configurations. Additionally or alternatively, there may be no gap between two RB sets. In other words, there may be a separation of zero, one, or more RBs between two contiguous RB sets within the BWP in the frequency domain.

In the FIG. 6, in the frequency domain, a interlace whose RBs have a lowest CRB index within the first RB set is the interlace m=4, while the interlace whose RBs have a lowest CRB index within the second RB set is the m=0.

In order to ensure a fair co-existence with another NR-U node and/or another radio access technology (RAT) node such as wireless LAN node, the base station 160 and/or the UE 102 may have to perform Listen Before Talk (LBT) procedure before their transmissions. LBT procedure is also referred to as Channel Access procedure. The base station 160 and/or the UE 102 may perform the channel access procedure to determine if there is the presence of other transmission in a channel before their transmission. There may be several types of Channel Access (CA) procedures. For example, Cat-1 LBT is a channel access procedure without channel sensing. Cat-2 LBT is a channel access procedure with one shot channel sensing. Cat-2 LBT may also be referred to as Type-2 channel access procedure. Cat-1 and Cat-2 LBTs may be allowed only inside COT. Cat-3 LBT is a channel access procedure with random backoff with a fixed contention window (CW) size. Cat-4 LBT is a channel access procedure with random backoff with an adaptive CW size. Cat-4 LBT may also be referred to as Type-1 channel access procedure.

In a BWP, before a gNB and/or a UE attempt to transmit a signal, the gNB and/or the UE may first perform channel sensing in each RB set to check whether a channel (or one or more RB sets within the BWP allocated for transmission) is available or not for transmission. If the channel or the allocated RB set(s) is sensed to be considered to be idle (i.e., the channel is available for transmission or the gNB and/or the UE gets a channel access successfully), the gNB and/or the UE may transmit on the channel or on the allocated RB set(s). On the other hand, if the channel or the allocated RB set(s) is sensed to be considered to be busy (i.e., the channel is not available or the gNB and/or the UE does not get a channel access successfully), the gNB and/or the UE may not transmit on the channel or on the allocated RB set(s).

Vehicle-to-everything (V2X) communication technologies have been developed by 3GPP for the automotive industry. V2X refers to a communication technology through which a vehicle exchanges information with another vehicle, a pedestrian, an object having an infrastructure, and so on. The V2X is divided into 4 types, such as vehicle-to-vehicle (V2V), vehicle-to-infrastructure (V2I), vehicle-to-network (V2N), and vehicle-to-pedestrian (V2P). Therefore, the V2X communication is different from the communication between the UEs and gNBs. The V2X communication enables the communication between the UEs, which is also called as sidelink. That is, sidelink communication supports UE-to-UE direct communication via a PC5 interface. In other words, sidelink communication is directly performed or communicated between one transmitting UE and one or more receiving UEs.

Sidelink communication consists of unicast, groupcast and broadcast. The unicast may refer to a communication between two UEs, i.e., one transmitting UE and one receiving UE. The groupcast and/or the broadcast may refer to a communication between one transmitting UE and multiple receiving UEs.

Currently NR Sidelink communication supports two sidelink resource allocation modes, mode 1 and mode 2. The difference between the sidelink resource allocation mode 1 and the sidelink resource allocation mode 2 lies in which determine the resource to be used for the sidelink communication.

In mode 1, the sidelink resource allocation is provided or determined by the base station and/or the network. That is, for mode 1, the base station may manage the resource allocation for the UEs. For example, a base station may allocate the resources for sidelink communication to an in-coverage UE. In sidelink resource allocation mode 1, dynamic grant, configured grant type 1 and configured grant type 2 are supported for PSSCH and PSCCH transmission. In sidelink resource allocation mode 1, for sidelink dynamic grant, the PSSCH transmission is scheduled by a DCI format 3_0. For sidelink configured grant type 1, the configured grant is provided (activated) or released (deactivated) by RRC signaling. For sidelink configured grant type 2, the configured grant is provided or released by PDCCH with the DCI format 3_0.

In mode 2, the sidelink resource allocation is determined by a TX UE itself. The UE may decide the sidelink transmission resources in a resource pool. The UE may carry out the resource allocation without involvement of the base station. These UEs may autonomously determine to select resources for sidelink communication based on a sensing-based procedure.

In mode 1, the DCI format 3_0 is used by the base station for scheduling of NR PSCCH and NR PSSCH in one cell. The base station may determine the scheduling information of NR PSCCH and NR PSSCH and provide the scheduling information to an in-coverage UE. The scheduling information may at least include a Resource pool index field, a time gap field, a HARQ process number field, a New data indicator field, a Lowest index of the subchannel allocation to the initial transmission field, SCI format 1-A fields, and so on. The Resource pool index field is used to indicate an index of a resource pool for which the sidelink transmission is scheduled and the SCI format 1-A fields here refer to the frequency resource assignment field and the time resource assignment field. That is, in mode 1, the base station may determine the time and frequency resource assignment for scheduling of sidelink transmission and then generate the corresponding fields of the scheduling information in the DCI format 3_0. A TX UE (an in-coverage UE) that received the DCI format 3_0 may transmit the PSCCH with SCI format 1-A and the PSSCH in the resource assigned by the base station based on the scheduling information in the DCI format 3_0. Moreover, the SCI format 1-A transmitted by the TX UE includes the frequency resource assignment field and the time resource assignment field which are as same as those included in the DCI format 3_0. A RX UE (an out-coverage UE and/or an in-coverage UE) that received the PSCCH with the SCI format 1-A can receive the PSSCH in the resource assigned by the base station.

In mode 2, a TX UE may autonomously determine to select resources for sidelink communication and generate the fields in SCI format 1-A to notify an RX UE of the time and frequency resource assignment. The RX UE that received the PSCCH with the SCI format 1-A can receive the PSSCH in the resource assigned by the TX UE.

Sidelink communication supports physical channels such as Physical Sidelink Control Channel (PSCCH), Physical Sidelink Shared Channel (PSSCH), Physical Sidelink Feedback Channel (PSFCH), and Physical Sidelink Broadcast Channel (PSBCH).

The PSCCH is used for transmitting/receiving sidelink control information (e.g., the 1^{st}-stage SCI). For example, the PSCCH indicates resource and other transmission parameters used by a UE for PSSCH reception. PSCCH transmission is associated with a DM-RS. For PSCCH, QPSK is supported.

The PSSCH is used for transmitting/receiving sidelink control information (e.g., the 2^{nd}-stage SCI), transport block(s) of data, and channel state information (CSI). The sidelink control information herein may include information, for example, for HARQ for HARQ procedures and CSI feedback triggers, etc. At least 6 OFDM symbols within a slot are used for PSSCH transmission. PSSCH transmission is associated with a DM-RS and may be associated with a PT-RS. For PSSCH, QPSK, 16QAM, 64QAM and 256QAM are supported.

PSFCH is used for carrying HARQ feedback over the sidelink from a UE which is an intended recipient of a PSSCH transmission to the UE which performed the PSSCH transmission. PSFCH sequence is transmitted in one PRB repeated over two OFDM symbols near the end of the sidelink resource in a slot.

The PSBCH is used for transmitting broadcast information. PSBCH occupies 9 and 7 symbols for normal and extended CP cases respectively, including the associated DM-RS.

Sidelink communication supports physical signals such as demodulation reference signal (DM-RS), phase-tracking reference signal (PT-RS), channel-state information reference signal (CSI-RS), sidelink synchronization signals.

The DMRS(s) are associated with PSCCH, PSSCH and/or PSBCH. A transmitting UE may transmit the DMRS within the associated sidelink physical channel. A receiving UE may use the DMRS to estimate and/or decode the associated sidelink physical channel.

The PT-RS is used to mitigate the effect of phase noise. A transmitting UE may transmit the PT-RS within the PSSCH transmission. The receiving UE may receive the PT-RS and use the PT-RS to mitigate the effect of phase noise.

The CSI-RS is used for measuring channel state information. A transmitting UE may transmit sidelink CSI-RS within a unicast PSSCH transmission. A receiving UE may measure the channel state information by using the CSI-RS and transmit a CSI report based on the measurement to the transmitting UE.

The Sidelink synchronization signal consists of sidelink primary and sidelink secondary synchronization signals (S-PSS, S-SSS), each occupying 2 symbols and 127 subcarriers. The sidelink synchronization signals are transmitted together with the PSBCH in a slot. Specifically, reception occasions of a PSBCH, S-PSS, and S-SSS are in consecutive symbols in a slot and form a S-SS/PBSCH block. For a SL-BWP, the S-SS/PBSCH block has a same SCS as the PSCCH, the PSSCH, and/or the PSFCH.

In various implementations of the present disclosure, a UE may be provided NR sidelink communication (pre-)configuration(s). For simplicity, (pre-)configuration(s) hereinafter refer to the NR sidelink communication (pre-)configuration(s). (Pre-)configuration(s) in the present disclosure may include configuration(s) received by system information (e.g., SIB 12) from a base station, configuration(s) received dedicated by RRC signaling (e.g., RRC configuration/parameters/message) from a base station, and/or configuration(s) preconfigured in the UE (i.e., pre-configuration). Regarding the pre-configuration, a memory unit of the UE may store the pre-configuration in advance.

In various examples or implementations of the present disclosure, (pre-)configuration(s) may include configuration(s) of one or more sidelink BWPs for sidelink communication. That is, a UE may receive the configuration(s) of the one or more BWPs included in system information, in dedicated RRC signaling, and/or in a pre-configuration. In the present disclosure, a UE may be provided by the (pre-)configuration(s) a BWP for sidelink transmissions.

In various examples or implementations of the present disclosure, a SL BWP configuration may include configuration(s) of one or more resource pools for sidelink communication. That is, the configuration(s) of the one or more resource pools (the configuration(s) related to the one or more resource pools) may be received in system information, received in dedicated RRC signaling, and/or preconfigured in a pre-configuration. According to the configuration(s), a resource pool may be indicated to be used either for sidelink communication reception or for sidelink communication transmission. Additionally or alternatively, a resource pool may be indicated to be used for both sidelink communication reception and sidelink communication transmission. Each resource pool is associated with either the sidelink resource allocation Mode 1 or the sidelink resource allocation Mode 2.

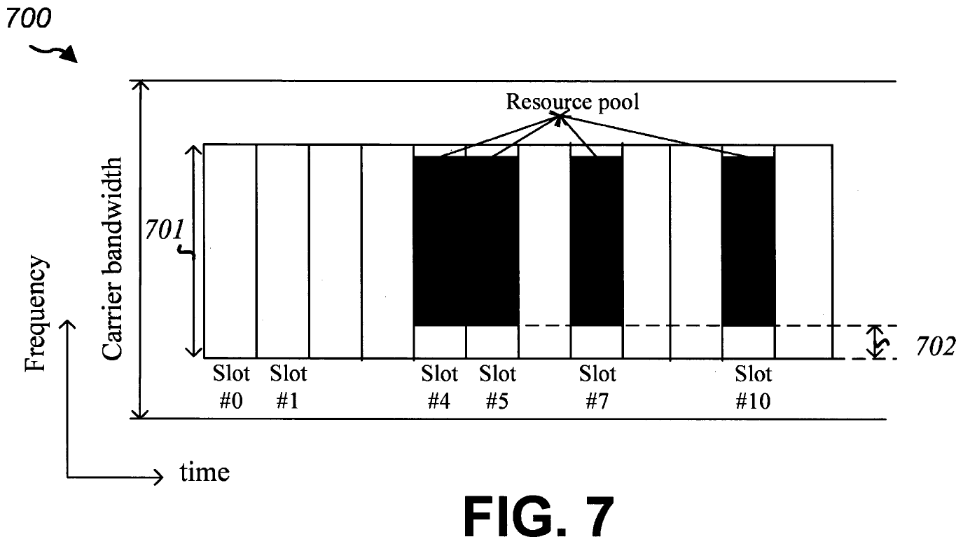

FIG. 7 is a diagram illustrating one example 700 of a SL BWP and a resource pool within the SL BWP.

A UE 102 is provided by a parameter SL-BWP-Config a BWP (a SL BWP) for sidelink transmission with numerology and resource grid. The determination of a SL BWP 701 is similar as how to determine a BWP specified in the FIG. 3.

In the FIG. 7, each block in the time domain represents a slot. One resource pool is configured within the SL BWP 701. The resource pool can be for transmission of PSSCH, PSCCH and/or PSFCH, and/or for reception of PSSCH, PSCCH and/or PSFCH. The first RB of the resource pool relative to the first RB of SL BWP, 702, may be indicated by a parameter included in the (pre-)configurations.

Not all the slots within the SL BWP may be assigned to a resource pool within the SL BWP. That is, not all the slots may belong to a resource pool. A slot assigned to a resource pool (or a slot belongs to a resource pool) can be also referred to a slot available for the resource pool. On the contrary, a slot not assigned to a resource pool (or a slot does not belong to a resource pool) can be also referred to a slot unavailable for the resource pool. Therefore, a resource pool may consist of a plurality (set) of non-contiguous slots in the time domain. In a SL BWP, different resource pools may be assigned with different sets of slots. The UE may determine the set of slots assigned to a resource pool according to the (pre-)configurations. A transmitting UE may transmit one or more physical SL channels or one or more SL signals in one or more resource pools within a SL BWP, while a receiving UE may receive one or more physical SL channels or one or more SL signals in one or more resource pools within a SL BWP.

In the FIG. 7, slot #0 refers to a first slot of a radio frame corresponding to SFN 0 of the serving cell or DFN 0. As illustrated in the FIG. 7, a set of slots with indexes #4, #5, #7 and #10 belong to the resource pool. The slots in the set for a resource pool are re-indexed such that the logical slot indexes are successive from 0 to T′ₘₐₓ−1 where the T′ₘₐₓ is the number of the slot in the set. For example, in the FIG. 7, the four slots in the set can be re-indexed as slots with logical slot indexes 0, 1, 2, and 3. The slots available for a resource pool may be provided or indicated by a parameter sl-TimeResource and may occur with a periodicity of 10240 ms.

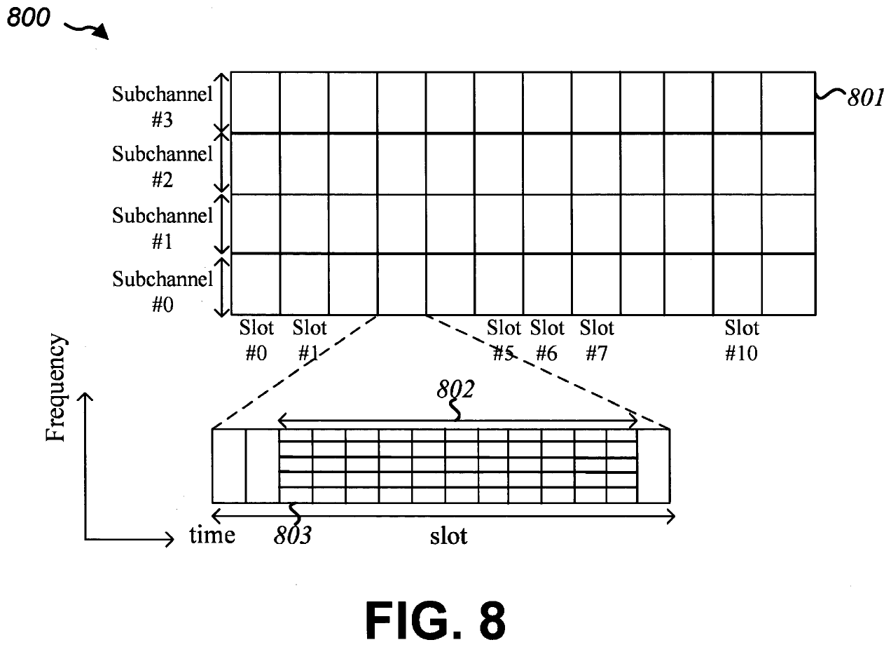

FIG. 8 is a diagram illustrating one example 800 of a resource pool configuration in time and frequency domain. In the FIG. 8, the resource pool is configured with the existing transmission scheme, which is specified in NR Releases 16/17. That is, the resource pool is not configured with the interlaced transmission scheme. For a resource pool configured with the existing transmission scheme, a PSSCH transmission/reception is performed in one or more contiguously allocated sub-channels in the frequency domain where each sub-channel consists of one or more contiguous RBs in the frequency domain.

A resource pool within a SL BWP can be divided into one or multiple contiguous sub-channels in the frequency domain. That is, a resource pool within a SL BWP consists of one or multiple contiguous sub-channels in the frequency domain. The number of the one or multiple sub-channels is indicated by a parameter sl-NumSubchannel included in the configuration of the resource pool. Each sub-channel includes a number of contiguous RBs in the frequency domain. The number of contiguous RBs is indicated by a parameter sl-SubchannelSize included in the configuration of the resource pool. In the FIG. 8, each block in the frequency domain represent a sub-channel of the resource pool 801. For example, in the FIG. 8, the parameter sl-NumSubchannel indicates that the number of one or multiple contiguous sub-channels is 4. That is, the resource pool 801 consists of 4 contiguous sub-channels in the frequency domain. The first RB of the first sub-channel of the resource pool 801 in the SL BWP may be indicated by a parameter sl-StartRB-Subchannel. The first sub-channel of a resource pool refers to a sub-channel with the lowest subchannel index in the resource pool. In the FIG. 8, the subchannel #0 is the first sub-channel of the resource pool 801, that is, the sub-channel with the lowest subchannel index 0. In the frequency domain, the frequency domain resource allocation granularity is one sub-channel for a PSSCH transmission. That is, for PSSCH transmission, the frequency domain unit is a sub-channel. A PSSCH transmission may be performed in one or more contiguous sub-channels in the frequency domain.

In the time domain, each block in the time domain represents a slot in the set of slots assigned to the resource pool 801. The slot indexes in the FIG. 8 refer to the logical slot indexes. The OFDM symbols within a slot assigned for sidelink transmission are provided by parameters included in the (pre-)configuration.

For example, SL transmissions can start from a first symbol indicated by a parameter sl-StartSymbol and be within a number of consecutive symbols indicated by a parameter sl-LengthSymbols. As in the FIG. 8, the duration 802 starts at the third OFDM symbol which is indicated by the parameter sl-StartSymbol and consists of 11 consecutive OFDM symbols which is indicated by the parameter sl-LengthSymbols. For a slot indicated for transmission of S-SS/PSBCH blocks, the first symbol and the number of consecutive symbols is predetermined.

A UE received a PSSCH transmission may transmit sidelink HARQ feedback via PSFCH to another UE which transmitted the PSSCH. Sidelink HARQ feedback can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs. Additionally, in sidelink resource allocation mode 1, a UE which received PSFCH can report sidelink HARQ feedback to gNB via PUCCH or PUSCH.

In NR Releases 16/17, sidelink communication was developed to operate in licensed spectrum. In NR Release 18, to further support commercial use cases with increased sidelink data rate, sidelink communication over unlicensed spectrum is under discussion. As above-mentioned, operation over unlicensed spectrum should fulfill different regulatory limitations and restrictions, e.g., OCB/NCB requirements. Interlaced transmission should be introduced for sidelink communication over unlicensed spectrum such that the regulatory requirement can be fulfilled.

For the sidelink transmissions over unlicensed spectrum, whether the OCB requirement is needed to be complied with is depending on region regulation. Therefore, for an unlicensed spectrum where OCB requirement is not required, the existing transmission scheme for sidelink physical channel and signals, which is specified in 3GPP NR Releases 16 and 17, can be reused for sidelink communication over the unlicensed spectrum. On the other hand, for an unlicensed spectrum where OCB requirement is required, the interlaced transmission scheme can be applied for sidelink communication over the unlicensed spectrum. In the present disclosure, to achieve a flexible and efficient design, a parameter A is introduced to indicate which scheme of the existing transmission scheme and the interlaced transmission scheme is applied for the sidelink transmission in a resource pool or in a SL BWP.

The parameter A may be a common parameter to a plurality of SL resource pools which are configured within a SL BWP. That is, a SL BWP configuration may include the parameter A such that the parameter A is a common indication of which scheme is applied to all the resource pools which are configured in the SL BWP provided by the SL BWP configuration. Specifically, in a case that the SL BWP configuration includes the parameter A, the interlaced transmission scheme is applied to all the resource pools configured in the SL BWP. That is, the UE 102 may determine to use interlaced transmission scheme for sidelink transmission/reception in all the resource pools configured in the SL BWP. In a case that the SL BWP configuration does not include the parameter A, the existing transmission scheme is applied to all the resource pools configured in the SL BWP. That is, the UE 102 may determine to not use interlaced transmission scheme and to use the existing transmission scheme for sidelink transmission/reception in all the resource pools configured in the SL BWP.

Additionally or alternatively, the parameter may be a dedicated parameter specific to a resource pool. That is, a resource pool configuration may include the parameter A such that the parameter A is a specific indication of which scheme is applied for a resource pool provided by the resource pool configuration. Specifically, in a case that a resource pool configuration includes the parameter A, the interlaced transmission scheme is applied to a resource pool configured by the resource pool configuration. That is, the UE 102 may determine to use interlaced transmission scheme for sidelink transmission/reception in the resource pool. In a case that a resource pool configuration does not include the parameter A, the existing transmission scheme is applied to a resource pool configured by the resource pool configuration. That is, the UE 102 may determine to not use interlaced transmission scheme and determine to use the existing transmission scheme for sidelink transmission/reception in the resource pool.

In the present disclosure, the existing transmission scheme can be also referred to as the existing design of sub-channel specified in NR Releases 16 and 17 where a sub-channel consists of contiguous PRBs in the frequency domain. While the interlaced transmission scheme can be also referred to as the new design of sub-channel which would be specified hereinafter. In the present disclosure, the terms “the existing transmission scheme” and “the existing design of sub-channel” may be used interchangeably. The terms “the interlaced transmission scheme” and “the new design of sub-channel” may be used interchangeably. In other words, the above-mentioned parameter A may be a parameter which is used to indicate which of the existing design of sub-channel and the new design of sub-channel is applied to a resource pool.

In the present disclosure, different from the new design of sub-channel, a sub-channel of a resource pool under the new design may consist of multiple contiguous or non-contiguous PRBs in the frequency domain. A sub-channel may be associated with one or more interlaces. A resource pool consists of one or more sub-channels in the frequency domain.

For a carrier with a SCS u, a number of intra-cell guard bands may be configured on the carrier with the SCS u. Each intra-cell guard band is defined by a start common resource block and a size in number of common resource blocks. For each intra-cell guard band, the start common resource block and the size in number of common resource blocks are provided by parameters, for example, parameters startCRB and nrofCRBs, respectively. The size of a guard band can be configured as 0 RB or non-zero RBs. For a carrier, if information of the intra-cell guard bands is not configured by parameters, the intra-cell guard bands may be predefined or predetermined for the carrier with a SCS u.

The intra-cell guard bands separate RB sets in the carrier with the SCS u. The number of intra-cell guard bands on a carrier with a SCS can be denoted as N_{RB-set}−1. That is, the UE is provided with N_{RB-set}−1 intra-cell guard bands on a carrier. The N_{RB-set}−1 intra-cell guard bands separate N_{RB-set} RB sets. That is, the number of RB set for the carrier is N_{RB-set}. Each RB set is defined by a start common resource block and an end common resource block in the frequency domain. The UE may determine a start common resource block and an end common resource block for an RB set based on the information of the intra-cell guard bands. Then an RB set consists of a plurality of contiguous common resource blocks in the frequency domain. For a carrier with different SCSs, an RB set may include different numbers of common resource blocks. For example, in a case that subcarrier spacing equals to 15 KHz, the number of resource blocks within an RB set may be configured to be between 100 and 110. In a case that subcarrier spacing equals to 30 kHz, the number of resource blocks within an RB set may be configured to be between 50 and 55. However, as an exception, for a resource pool, at most one RB set may be configured to contain 56 resource blocks. Specifically, a single RB set is defined by a starting common RB and an ending common RB in the frequency domain.

A UE may be configured with one or more SL BWP on the carrier with the SCS u. In the frequency domain, a SL BWP may be configured to include one or more RB sets on the carrier. The number of the one or more RB sets within a SL BWP are based on the configured bandwidth of the SL BWP. The one or more RB sets within a SL BWP can be denoted as N_{RB-set}^{BWP} where N_{RB-set}^{BWP} can be less than or equal to N_{RB-set}. The one or more RB sets within a SL BWP are indexed from 0 to N_{RB-set}^{BWP}−1 in the order of increasing frequency of the SL BWP and starting at the lowest frequency.

Likewise, the UE may be configured with one or more SL resource pools within a SL BWP on the carrier with the SCS u. In the frequency domain, a SL resource pool may be configured to include one or more RB sets within the SL BWP on the carrier. The number of RB sets included in a SL resource pool are based on the configured bandwidth of the resource pool. The RB sets included in a SL resource pool can be denoted as N_{RB-set}^{RP} where N_{RB-set}^{RP} can be less than or equal to N_{RB-set}^{BWP}. The RB sets included in a resource pool are indexed from 0 to N_{RB-set}^{RP}−1 in the order of increasing frequency of the resource pool and starting at the lowest frequency.

In the present disclosure, a SL BWP and/or a resource pool may be divided into one or more RB sets, where each of the one or more RB sets does not overlap with each other in the frequency domain. That is, the one or more RB sets do not have overlapping RBs in the frequency domain. The one or more RB sets within the resource pool are indexed from 0 in the order of increasing frequency of the one or more RB sets.

Additionally or alternatively, a guard band including zero, one or multiple RBs may separate two consecutive RB sets amongst the one or more RB sets within a resource pool.

For a resource pool that is configured with interlaced transmission, each RB of the resource pool is mapped to an RB of an interlace m. Furthermore, each RB within a resource pool is mapped to an interlace. In other words, in the present disclosure, a resource pool may consist of a plurality of interlaces. In the frequency domain, a resource pool is divided into a number of interlaces M where each interlace consists of non-contiguous (common) resource blocks. As above-mentioned, the value of M is determined per SCS.

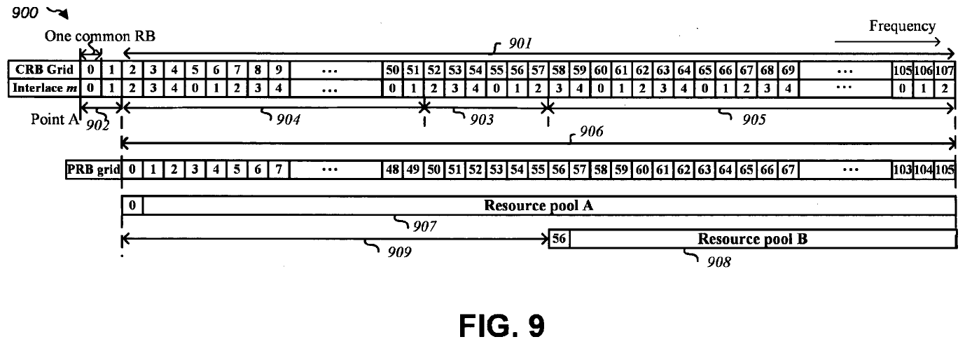

FIG. 9 is a diagram illustrating one example 900 of configurations of a SL BWP and SL resource pools.

As in the FIG. 9, a CRB grid is used to represent the common resource blocks in a carrier with a SCS. That is, a CRB index is used to represent a CRB in the carrier. The CRBs in the carrier are indexed from 0 in an order of increasing frequencies and starting from point A. Here, as an example in the FIG. 9, the carrier 901 uses the subcarrier spacing configuration μ=1, i.e., the SCS=30 kHz. The starting position N_{grid}^{start,μ} of the carrier 901 is given based on the value of an offset 902 (i.e. O_{carrier}) indicated by a parameter (e.g., the above-mentioned offsetToCarrier). That is, the carrier 901 starts from the CRB with index 2, i.e., the N_{grid}^{start,μ}=2, and includes a plurality of contiguous CRBs with index from 2 to 107. That is, the carrier bandwidth N_{grid}^{size,μ} of the carrier 901 in number of RBs is 106.

Each CRB on the carrier is mapped to an interlace m where the mapping between CRBs and interlaces are performed cyclically from 0 to M−1 in an order of increasing frequencies of CRBs. As in the FIG. 9, CRBs on the carrier are mapped to an interlace cyclically from 0 to 4 in the order of increasing frequencies of the CRBs and starting from the lowest frequency of a CRB.

As illustrated in the FIG. 9, a number of intra-cell guard band is equal to 1, i.e., N_{RB-set}−1=1. As above-mentioned, the intra-cell guard band 903 can be defined by a start CRB and a size in number of CRBs provided by a parameter startCRB and a parameter nrofCRBs, respectively. Specifically, the parameter startCRB indicates an RB offset relative to the starting CRB of the carrier 901. A CRB index of a starting CRB of an intra-cell guard band is given by its corresponding parameter startCRB and the N_{grid}^{start,μ} of the carrier 901. In the FIG. 9, the parameter startCRB indicates an RB offset as 50. The starting CRB of the intra-cell guard band 903 is determined by the summation of the RB offset and the N_{grid}^{start,μ}, i.e., the starting CRB of the intra-cell guard band 903 is the CRB with index 52. And the intra-cell guard band 903 includes 6 CRBs that is provided by the parameter nrofCRBs.

Then the intra-cell guard band 903 separates two RB sets 904 and 905 in the carrier 901, i.e., N_{RB-set}=2. Within the carrier, the RB sets are indexed from 0 to N_{RB-set}−1 in an order of increasing frequencies. The RB set 904 can be indexed with 0, i.e., the RB set 904 refers to the RB set 0 within the carrier 901. Likewise, the RB set 905 can be indexed with 1, i.e., the RB set 905 refers to the RB set 1 within the carrier 901.

The starting position (the starting CRB) of the RB set 904 is the starting position N_{grid}^{start,μ} of the carrier 901. The ending CRB of the RB set 904 is determined based on the starting position N_{grid}^{start,μ} of the carrier 901 and the RB offset provided by the parameter startCRB for the intra-cell guard band 903. Additionally, the starting CRB of the RB set 905 is determined based on the starting position N_{grid}^{start,μ} of the carrier 901, the RB offset provided by the parameter startCRB for the intra-cell guard band 903, and the size of the intra-cell guard band 903 by the parameter nrofCRBs. The ending CRB of the RB set 905 is determined based on the starting position N_{grid}^{start,μ} of the carrier 901 and the size N_{grid}^{size,μ} of the carrier 901.

In the present disclosure, a SL BWP can be configured to include one, more or all RB sets within the carrier. In the FIG. 9, a SL BWP 906 is configured to include all RB sets within the carrier 901. That is, the number of RB sets within the SL BWP 906 is same as that within the carrier 901. Likewise, the RB sets within a SL BWP are numbered in increasing order from 0.

A PRB grid is used to represent the physical resource blocks in a SL BWP. That is, a PRB index is used to represent a PRB in the SL BWP. The PRBs in the BWP are indexed from 0 in an order of increasing frequencies. A PRB in a SL BWP corresponds to a CRB in a carrier. Likewise, a PRB in a BWP corresponds to an RB of an interlace m in a carrier. As illustrated in the FIG. 9, the PRB with index 0 corresponds to the CRB with index 2, the PRB with index 1 corresponds to the CRB with index 3, and so on. Likewise, the PRB with index 0 corresponds to an RB of interlace m=2. The PRB with index 1 corresponds to an RB of interlace m=3.

In various examples or various implementations of the present disclosure, one or more SL resource pools can be configured within a SL BWP on the carrier with the SCS u. A SL resource pools can be configured to include one or more RB sets of a SL BWP in the frequency domain. As illustrated in FIG. 9, two SL resource pools, i.e., a SL resource pool 907 and a SL resource pool 908 are configured in the SL BWP 906. The SL resource pool 907 is configured to include the RB set 904, the RB set 905, and the guard band 903 in the frequency domain. The SL resource pool 908 is configured to include the RB set 905 in the frequency domain. That is, different SL resource pools can be configured with different number of RB sets within a SL BWP, which are depending on configured bandwidths of the resource pools. The RB sets included in a SL resource pool can be denoted as N_{RB-set}^{RP} where N_{RB-set}^{RP} can be less than or equal to N_{RB-set}^{BWP}. The RB sets included in a resource pool are indexed from 0 to N_{RB-set}^{RP}−1 in the order of increasing frequency of the resource pool and starting at the lowest frequency. The resource pool 907 includes N_{RB-set}^{RP}=2 RB sets and the resource pool 908 includes N_{RB-set}^{RP}=1 RB set.

In the FIG. 9, the resource pool 907 starts in a RPB with index 0 relative to the starting PRB of the SL BWP (i.e., PRB with index 0), while the resource pool 908 starts in a RPB with index 56 relative to the starting PRB of the SL BWP (i.e., PRB with index 0). A SL BWP and/or a resource pool is configured not to include parts of an RB set. In the present disclosure, a SL BWP and/or a resource pool may be configured to start on an RB with a lowest CRB index within a first RB set and to end an RB with a largest CRB index within a second RB set. The first RB set and the second RB set can refer to a same RB set or different RB sets within the carrier. In other words, a starting RB of a SL BWP and/or a SL resource pool is a starting RB of an RB set. Likewise, an ending (last) RB of a SL BWP and/or a SL resource pool is an ending RB of an RB set.

In the present disclosure, the resource pool may consist of one or more sub-channels. The one or more sub-channels are indexed in increasing order from 0 to N_{subch}−1 where the N_{subch} is the number of the one or more sub-channels included in the resource pool. If the interlaced transmission is configured to apply to the resource pool, to adapt to the interlaced transmission, the mapping between interlaces and the one or more sub-channels of the resource pool is provided. The UE 102 (e.g., the control unit of the UE 102) may determine, which one or more interlaces of the M interlaces are included (or grouped) in a sub-channel of the one or more sub-channels of the resource pool at least based on a parameter B and/or a parameter C.

In other words, the UE 102 may determine, for a sub-channel, a starting interlace index and a number of interlaces based on the parameter B and/or the parameter C.

In an example, the parameter C is introduced to indicate a number of interlaces, K, where the K interlaces are included in a sub-channel. That is, K interlaces are formed to a sub-channel. A sub-channel may consist of K interlaces. The UE may determine the number of the one or more sub-channels N_{subch} based on the parameter C and M. Specifically, the N_{subch} may be determined or calculated as ceiling (M mod K) or as M mod K. The mod function refers to the Modulo operation and the ceiling (A) function hereinafter is to output a smallest integer not less than A. For example, in case of SCS=15 kHz (i.e., M=10), the value of K indicated by the parameter C may be 1, 2, 2.5, 5, or 10. In case of SCS=30 kHz (i.e., M=5), the value of K indicated by the parameter C may be 1, 2.5, or 5. The K interlaces may be also referred to as one or more interlaces. For convenience of description, ceiling (M mod K) and M mod K can be used interchangeably.

Additionally or alternatively, the SL resource pool configuration may not include the parameter C. The UE 102 may determine the value of K as a default value or a predefined value. For example, in a case that the SL resource pool configuration may not include the parameter C, the UE 102 may determine K=1 or K=M. That is, if a SL resource pool configuration aims to set K as the default value, the SL resource pool configuration is not necessary to always include the parameter C so that signaling overhead of the parameter C can be reduced.

In an example, the parameter B is introduced to determine or indicate a starting interlace index m₀. The UE 102 may determine the starting interlace index m₀ based on the parameter B for a resource pool. The starting interlace index m₀ may be used to determine a sub-channel with the lowest index in the resource pool. The starting interlace index m₀ is an interlace of K interlaces included in the lowest sub-channel. The lowest sub-channel refers to a sub-channel with a lowest sub-channel index.

The parameter B may refer to the above-mentioned parameter sl-StartRB-Subchannel. As above-mentioned, the parameter sl-StartRB-Subchannel is used to indicate the first (starting, lowest) RB index of a lowest sub-channel in a resource pool with respect to the lowest RB index of a SL BWP. The lowest RB index of a SL BWP refers to the PRB 0 of the SL BWP. The UE may determine the interlace m₀ based on the parameter B. Specifically, the UE may determine the first RB of the lowest sub-channel based on the parameter B. Then the UE may determine the interlace m₀ wherein the interlace m₀ includes the first RB of the lowest sub-channel. That is, the first RB of the lowest sub-channel is an RB of the interlace m₀.

In an example, the parameter B may be an indication of interlace m₀. The parameter B may be used to indicate an interlace m₀ for a sub-channel within a lowest index within a resource pool or within an RB set of a resource pool.

As illustrated in the FIG. 9, for the resource pool 907, the parameter sl-StartRB-Subchannel indicates 0, that is, the first RB of a lowest sub-channel in the resource pool 907 is the lowest RB index of the SL BWP 906. The RB offset between the resource pool 907 and the SL BWP 906 is zero RB. The first RB of the resource pool 907 is the PRB 0 of the SL BWP 906 where the PRB 0 corresponds to the CRB 2 and is a RB of the interlace m=2. The UE may determine the interlace m₀=2 for the resource pool 907.

Additionally, for the resource pool 908, the parameter sl-StartRB-Subchannel indicates 56, that is, the first RB of a lowest sub-channel in the resource pool 907 is a PRB with index 56 with respect to the lowest RB index of the SL BWP 906. That is, the parameter sl-StartRB-Subchannel indicates the RB offset 909 between the resource pool 908 and the SL BWP 906. The first RB of the resource pool 908 is the PRB 56 of the SL BWP 906 where the PRB 56 corresponds to the CRB 58 and is a RB of the interlace m=3. The RB offset 909 between the resource pool 908 and the SL BWP 906 is 55 RB. The UE may determine the interlace m₀=3 for the resource pool 908. Therefore, in the present disclosure, different resource pools in a same SL BWP may have same or different starting interlaces m₀.

Upon determine the starting interlace index m₀, the UE 102 may determine the K interlace indexes for a sub-channel. The UE 102 may determine that a sub-channel with a lowest index includes the K interlaces with indexes calculated as (m₀+j) mod M for j=0, 1, . . . , K−1. The UE 102 may determine that a sub-channel with an index i includes K interlaces with indexes calculated as ((m₀+floor (i*K)) mod M+j) mod M for j=0, 1, . . . , K−1. The M is 10 in a case that a subcarrier spacing (SCS) of the SL BWP is 15 kHz and 5 in a case that the SCS is 30 kHz. For convenience of description, floor (i*K) and floor (i*K) can be used interchangeably.

In the present disclosure, there are two concepts of designing the sub-channel in a resource pool. One is that a sub-channel is within an RB set. The other one is that a sub-channel is across all the RB sets included in a resource pool.

In the present disclosure, the concept (the first concept) that a sub-channel is within an RB set may imply that RBs of a sub-channel are within an RB set in the frequency domain. The RBs of a sub-channel do not belong to more than one RB set. The UE may determine the K interlaces for a sub-channel. The UE may further determine the RBs of the sub-channel as an intersection of the RBs of the determined K interlaces and a single RB set of the resource pool. According to the first concept of sub-channel, the N_{subch} may be determined or calculated as (M mod K)*N_{RB-set}^{RP}.

There are (M mod K) sub-channels within each RB set. Hereinafter, an RB set r may refer to an RB set with an RB set index r. For a resource pool including N_{RB-set}^{RP} RB sets, the RB set index r is that r=0, 1, . . . , N_{RB-set}^{RP}−1. The sub-channels within an RB set r have indexes as (M mod K)*r, (M mod K)*r+1, . . . , (M mod K)*(r+1)−1. That is, the sub-channels within an RB set r have indexes as (M mod K)*r+n where n=0, 1, . . . , (M mod K)−1.

According to the first concept of sub-channel, for a sub-channel with index i where i=0, 1, . . . , N_{subch}−1, the UE 102 may determine that a sub-channel with an index i includes K interlaces with indexes calculated as ((m₀+floor (i*K)) mod M+j) mod M for j=0, 1, . . . , K−1. The M is 10 in a case that a subcarrier spacing (SCS) of the SL BWP is 15 kHz and 5 in a case that the SCS is 30 kHz.

Additionally or alternatively, according to the first concept of sub-channel, the UE may determine a starting interlace m_{0,r} for a sub-channel with the lowest index within an RB set r based on a lowest RB index in the RB set r. The UE 102 may determine the first RB of the RB set r wherein the first RB is an RB with a lowest RB index (a lowest CRB index, or a lowest frequency) in the RB set r in the frequency domain. And the UE 102 may determine the interlace m_{0,r} wherein the interlace m_{0,r} includes the first RB of the RB set r. The UE 102 determined that a sub-channel with a lowest index within an RB set r includes the K interlaces with indexes calculated as (m_{0,r}+j) mod M for j=0, 1, . . . , K−1. The UE 102 may determine that, for an RB set r, a sub-channel with an index (M mod K)*r+n includes K interlaces with indexes calculated as ((m_{0,r}+floor (n*K)) mod M+j) mod M for j=0, 1, . . . , K−1.

Upon determining the K interlace indexes for a sub-channel, the UE may further determine the RBs of the sub-channel as an intersection of the RBs of the determined K interlaces and a single RB set of the resource pool. That is, the sub-channel may consist of resource blocks where the resource blocks are an intersection of the RBs of the determined K interlaces and a single RB set of the resource pool. Here the determined K interlaces is the interlaces which are mapped to the sub-channel. The single RB set is an RB set where the sub-channel is located.

In the present disclosure, the concept (the second concept) that a sub-channel is across all the RB sets of the resource pool may imply that RBs of a sub-channel are across all RB sets. The RBs of a sub-channel belong to more than one RB set if the resource pool includes more than one RB set. The UE may determine the K interlaces for a sub-channel. The UE may further determine the RBs of the sub-channel as an intersection of the RBs of the determined K interlaces and all RB sets of the resource pool. A sub-channel may not include the RBs of the determined K interlaces which locate in the intra-cell guard bands included in the resource pool. Additionally or alternatively, the UE may further determine the RBs of the sub-channel as an intersection of the RBs of the determined K interlaces and the union of all RB sets of the resource pool and intra-cell guard bands included in the resource pool. According to this concept of sub-channel, the N_{subch} may be determined or calculated as (M mod K). That is, there are (M mod K) sub-channels within a resource pool.

According to the second concept of sub-channel, for a sub-channel with index i where i=0, 1, . . . , N_{subch}−1, the UE 102 may determine that a sub-channel with an index i includes K interlaces with indexes calculated as ((m₀+floor (i*K)) mod M+j) mod M for j=0, 1, . . . , K−1.

In the present disclosure, the sub-channels in a resource pool may have equal number(s) of interlace(s). Additionally or alternatively, the sub-channels in the resource pool may also have unequal numbers of interlaces. The unequal numbers of interlaces may be determined based on the values of M and K. Specifically, the UE may determine that a resource pool has a first set of sub-channels and a second set of sub-channels wherein a sub-channel in the first set includes the K interlaces and a sub-channel in the second set includes the (M mod K) interlace(s). The second set may include one sub-channel with largest index in a resource pool or in an RB set.

For example, the parameter C may indicate K=2. In case of M=5, the UE may determine first two sub-channels which includes K=2 interlaces and may determine a last sub-channel which include the remaining one interlace. By supporting unequal numbers of interlaces included in sub-channel, a more flexible mapping between a sub-channel and interlaces can be provided, which can enable a more efficient use of interlaces for a SL resource pool.

In the present disclosure, a PSCCH transmission is performed within a sub-channel. As above-mentioned, a sub-channel may include K interlaces where K can be equal to 1 or larger than 1. The UE may receive a parameter D to indicate a number of PRBs in the resource pool where the number of PRBs is for PSCCH transmission in the resource pool. For the purpose of illustration, the parameter D indicates L PRBs for PSCCH in the resource pool. The UE 102 may determine which RBs in a sub-channel to be used as the PRBs for PSCCH transmission. That is, the UE 102 may need to determine L PRBs from the RBs of a sub-channel in the following order, that is, first in increasing order of interlace indexes within the K interlaces, and then in increasing order of the RB indexes within an interlace. The RB indexes may refer to the CRB indexes, the PRB indexes, or the frequencies indexes of RBs. According to the value of L PRBs, L PRBs may be mapped to one or more interlaces of a sub-channel. That is, a PSCCH transmission may be performed in one or more interlaces within an RB set. In a case that a sub-channel is across more than one RB set, the L PRBs for PSCCH should be determined in an RB set with the lowest RB set index among the more than one RB set.

Sidelink control information is split into two stages, i.e., 1^{st}-stage SCI and 2^{nd}-stage SCI. Specifically, SCI carries on PSCCH is the 1^{st}-stage SCI, which transports sidelink scheduling information. That is, the 1^{st}-stage SCI is sent on PSCCH. The SCI carries on PSSCH is the 2^{nd}-stage SCI, which transports sidelink scheduling information, and/or inter-UE coordination related information. That is, the 2^{nd}-stage SCI is send on PSSCH.

The fields of the 1^{st}-stage SCI formats (e.g., the SCI format 1-A) are mapped to the information bits of the 1^{st}-stage SCI. The SCI format 1-A is used for the scheduling of PSSCH and 2^{nd}-stage SCI on PSSCH.

The SCI format 1-A may include the following fields, e.g., Priority, Frequency resource assignment, Time resource assignment, Resource reservation period, DMRS pattern, 2^{nd}-stage SCI format, Beta_offset indicator, Number of DMRS port, Modulation and coding scheme, Additional MCS table indicator, PSFCH overhead indication, Reserved, Conflict information receiver flag. As above-mentioned, in Mode 1, the UE may obtain the time resource assignment field and the frequency resource assignment field from DCI format 3_0 and include them in SCI format 1-A. In mode 2, the UE may determine the resource allocation for sidelink transmission and generate the time resource assignment field and the frequency resource assignment field in SCI format 1-A.

The fields defined in each of the 2^{nd}-stage SCI formats (e.g., the SCI format 2-A, SCI format 2-B, SCI format 2-C) are mapped to the information bits of the 2^{nd}-stage SCI. The SCI format 2-A is used for the decoding of PSSCH, with HARQ operation when HARQ-ACK information includes ACK or NACK, when HARQ-ACK information includes only NACK, or when there is no feedback of HARQ-ACK information. The SCI format 2-B is used for the decoding of PSSCH, with HARQ operation when HARQ-ACK information includes only NACK, or when there is no feedback of HARQ-ACK information. The SCI format 2-C is used for the decoding of PSSCH, and providing inter-UE coordination information or requesting inter-UE coordination information.

In NR Releases 16/17, a PSFCH transmission is performed in one PRB in the frequency domain. In NR Release 18, sidelink transmissions over the unlicensed spectrum are under discussion. Whether transmissions over the unlicensed spectrum need to meet the OCB requirement is depending on the region regulation and/or the band regulation for the unlicensed spectrum. In a case that the OCB requirement is not required for unlicensed spectrum in some regions or bands, the one PRB-based PSFCH transmission, which is specified in the NR Releases 16/17, can be applied to the PSFCH transmission over the unlicensed spectrum. On the other hand, in a case that the OCB requirement is required for unlicensed spectrum in some regions or bands, the one PRB-based PSFCH transmission cannot be applied to the PSFCH transmission over the unlicensed spectrum. In this case, interlace-based PSFCH should be introduced and determination for PSFCH resource(s) over unlicensed spectrum is necessary and would be beneficial to adapt to the PSFCH transmission over the unlicensed spectrum. However, methods for how to determine PSFCH resources over unlicensed spectrum has not been provided so far. Furthermore, how to index the PSFCH resources over unlicensed spectrum has not been discussed as well. The present disclosure provides new methods and solutions on how to determine PSFCH resources including cyclic shift and how to index the PSFCH resources in a resource pool over unlicensed spectrum, which would provide a more efficient and flexible sidelink communication system over unlicensed spectrum.

Hereinafter, for purposes of illustration, a TX UE refers to a UE which transmits the PSCCH and/or the PSSCH in a resource pool. A RX UE refers to a UE which receives the PSCCH and/or the PSSCH in a resource pool. In response to the reception of the PSSCH, the RX UE may transmit, to the TX UE, a PSFCH transmission with HARQ-ACK information in a PSFCH resource. The HARQ-ACK information corresponding to one HARQ-ACK information bit may include ACK or NACK, or only NACK. The TX UE may receive the PSFCH transmission from the RX UE in a PSFCH resource.

In the present disclosure, whether to perform interlaced PSFCH transmission/reception or to perform one RB-based PSFCH transmission/reception in a resource pool may be indicated by the above-mentioned parameter A. Additionally or alternatively, whether to perform interlaced PSFCH transmission/reception in a resource pool may be indicated by a parameter other than the above-mentioned parameter A. That is, the parameter A may be used to indicate whether the PSCCH and/or the PSSCH transmission/reception is performed in interlaced transmission scheme or in existing transmission scheme. While a parameter other than the parameter A may be used to indicate whether to perform interlaced PSFCH transmission/reception or to perform one RB-based PSFCH transmission/reception in a resource pool.

In the present disclosure, for a resource pool configured with resources for PSFCH, each PSFCH resource includes a time domain resource, a frequency domain resource, and a code domain resource. In other words, a PSFCH resource may be mapped to a time domain resource, a frequency domain resource, and a code domain resource. In other words, a PSFCH resource can be defined by a time domain resource, a frequency domain, a code domain resource.

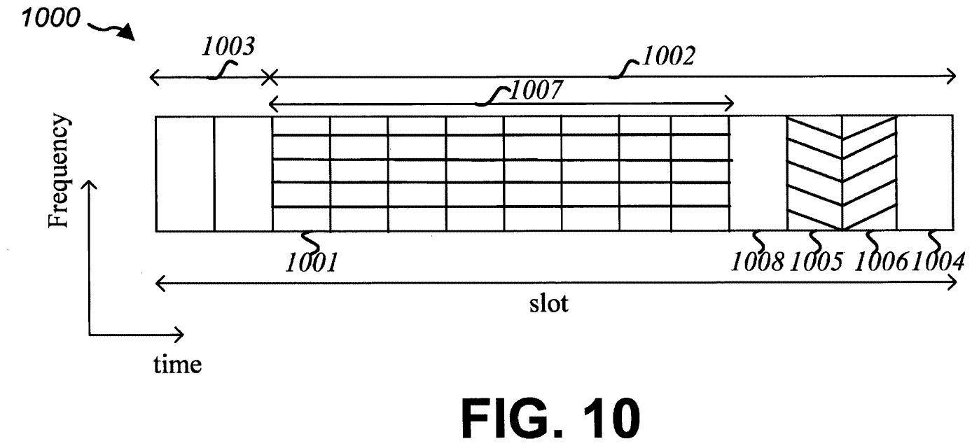

FIG. 10 is a diagram illustrating one example 1000 of a slot with PSFCH resources in a resource pool.

In the time domain, PSFCH resources may be (pre-)configured periodically with a period

$${N}_{PSSCH}^{PSFCH}$$

in the unit of slots within the resource pool wherein the value of

$${N}_{PSSCH}^{PSFCH}$$

is indicated by a parameter sl-PSFCH-Period which is included in the resource pool configuration. For example, the value of

$${N}_{PSSCH}^{PSFCH}$$

may be indicated as 0, 1, 2 or 4. In a case the value of

$${N}_{PSSCH}^{PSFCH}$$

is indicated to be 0, the TX UE and the RX UE may determine there is no resource for PSFCH and the PSFCH transmissions (i.e., the HARQ feedbacks for PSSCH transmissions) in the resource pool are disabled. In a case the value of

$${N}_{PSSCH}^{PSFCH}$$

is indicated to be not 0, the TX UE and the RX UE may determine resources for PSFCH are periodically configured every

$${N}_{PSSCH}^{PSFCH}$$

slot(s) within the resource pool.

As above-mentioned, a parameter sl-StartSymbol indicates a starting symbol used for sidelink in a slot. A parameter sl-LengthSymbols indicates a number of consecutive symbols used for sidelink in a slot. For example, in FIG. 10, the parameter sl-StartSymbol indicates that a starting symbol used for sidelink in a slot is the third symbol 1001 in a slot. And the parameter sl-LengthSymbols indicates the number of consecutive symbols 1002 used for sidelink in a slot is 12. That is, the 1002 consists of 12 consecutive OFDM symbols in a slot. The symbol 1001 is the first symbol of the consecutive symbols 1002. As in the FIG. 10, symbols within 1002 in a slot are configured for sidelink. On the other hand, symbols within 1003 (i.e., symbols outside 1002) in a slot are not configured for sidelink. The UE may not transmit the PSSCH in symbols which are not configured for sidelink in a slot. The UE may transmit the PSSCH in symbols which are configured for sidelink in a slot.

In a slot where PSFCH resources are not configured, the UE may transmit the PSSCH in the consecutive symbols 1002 except the first symbol and the last symbol of 1002 where the first symbol of 1002 (i.e., the symbol 1001) is used as an automatic gain control (AGC) symbol and the last symbol of 1002 (i.e., the symbol 1004) is used as a guard symbol. An AGC symbol is used to adjust the strength of the received signal in order to reduce the quantization error or the clipping of the received signal at the analog to digital converter. A guard symbol is used for timing adjustment and for switch between transmission and reception by a UE.

However, in a slot where PSFCH resources are configured, a portion of the consecutive symbols 1002 may be used for PSFCH. Specifically, a second-to-last symbol in the 1002 is used for PSFCH transmission and therefore can be called as PSFCH symbol. That is, the symbol 1006 is a PSFCH symbol in the slot. The OFDM symbol prior to the PSFCH symbol is used as an AGC symbol. The signal transmitted in the PSFCH symbol would be duplicated in the AGC symbol. In other words, the AGC symbol 1005 is a duplicated symbol of the PSFCH symbol 1006. Therefore, symbols 1007 are used for PSSCH transmission. A symbol 1008 between the PSSCH transmission and the PSFCH transmission is used as a guard symbol. As shown in the FIG. 10, PSSCH and PSFCH may be multiplexed in the time domain in the slot where PSFCH resources are configured.

A PSFCH resource in the frequency domain may include a PRB or an interlace according to whether the PSFCH transmission in the resource pool is configured with interlaced PSFCH transmission or not. For a resource pool where one PRB-based PSFCH transmission is configured (i.e., interlaced PSFCH transmission is not configured), each PSFCH resource may be mapped to a PRB in the frequency domain. That is, one PRB of the resource pool is used for a PSFCH transmission. On the other hand, for a resource pool where interlaced PSFCH transmission is configured, each PSFCH resource may be mapped to an interlace in in the frequency domain. That is, PRBs of an interlace in the resource pool are used for a PSFCH transmission.

According to the configured bandwidth of a resource pool, the resource pool may include one or more RB sets. Then, PRBs of an interlace within the resource pool includes PRBs of the interlace in all RB sets and PRBs of the interlace in intra-cell guard band(s) if present in the resource pool. Using all the PRBs of an interlace within the resource pool as a PSFCH resource would not only lead to the resource waste but also increase the risk of LBT failure. Therefore, it would be beneficial to confine the frequency domain resource of a PSFCH resource for a PSFCH transmission in an RB set. Specifically, the frequency resource of a PSFCH resource corresponds to the PRBs of an interlace which are within an RB set. The PRBs of a same interlace within different RB sets corresponds to different PSFCH resources. For example, the frequency resources of a PSFCH resource may include PRBs of interlace #0 in RB set #0 while the frequency resources of a different PSFCH resource may include PRBs of interlace #0 in RB set #1. ‘A PSFCH resource is mapped to an interlace in an RB set’ means ‘a PSFCH resource is mapped to PRBs of an interlace in an RB set’. Therefore, in the present disclosure, for a resource pool where interlaced PSFCH transmission is configured, each PSFCH resource may be mapped to an interlace in an RB set in the frequency domain. That is, PRBs of an interlace in an RB set in the resource pool are used for a PSFCH transmission.

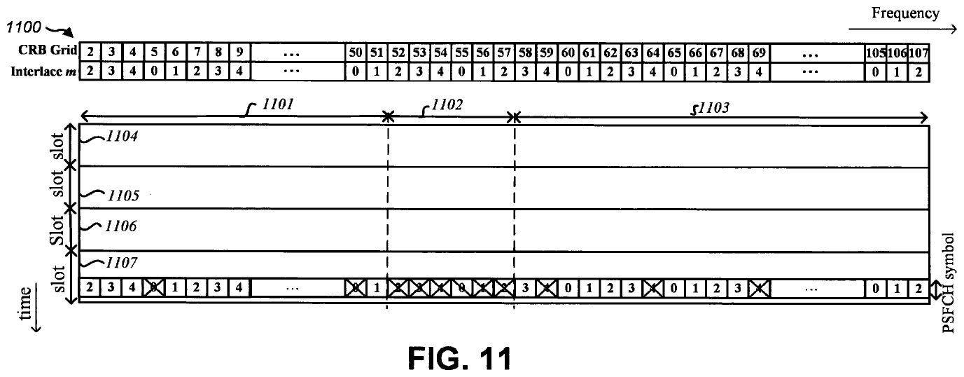

FIG. 11 is a diagram illustrating one example 1100 of a resource pool configured with PSFCH resources. The subcarrier spacing configuration for the resource pool is μ=1, i.e., the SCS=30 kHz. Therefore, the value of M is equal to 5.

The resource pool in the frequency domain includes two RB sets 1101 and 1103 and one intra-cell guard band 1102. A resource pool configuration may include a parameter to indicate whether there are resources for PSFCH configured for the resource pool. In the FIG. 11, the resource pool is configured with PSFCH resources.

The resource pool configuration may provide (include) information A related to time resources for PSFCH reception/transmission. For example, the information A may indicate the location of the PSFCH symbol in a slot where PSFCH resources are configured. For example, the information A may indicate the period of the PSFCH resources

$${N}_{PSSCH}^{PSFCH} .$$

The TX/RS UEs may determine, in the resource pool, whether a slot includes the PSFCH resources according to the slot index k and the value of

$${N}_{PSSCH}^{PSFCH} .$$

In a case that k mod

$${N}_{PSSCH}^{PSFCH} = 0 ,$$

the TX/RX UEs may determine the slot with the slot index k includes PSFCH resources. Otherwise, the TX/RX UEs may determine the slot with the slot index k does not include PSFCH resources.

In the FIG. 11, for example, the period of the PSFCH resources

$${N}_{PSSCH}^{PSFCH}$$

is indicated to be 2 by the parameter sl-PSFCH-Period included in the information A. Therefore, the PSFCH resources would occur every

$${N}_{PSSCH}^{PSFCH} = 2$$

slots in the resource pool. In the FIG. 11, for example, the slot 1107 is a slot where PSFCH resources are configured or included. A RX UE may transmit a PSFCH in the slot 1107 in response to the reception of a given PSSCH. Given

$${N}_{PSSCH}^{PSFCH} = 2$$

slots in the resource pool, two slots where PSSCHs are transmitted are associated with the PSFCH symbol in a slot including the PSFCH resources. The information A may further provide information which can be used by the TX/RX UEs to determine which

$${N}_{PSSCH}^{PSFCH} = 2$$

slots are associated with a slot including PSFCH information. The information provided by the information A may be a time gap in unit of slots. That is, the time gap is a number of slots, T, which may be indicated by a parameter or a SCI format. The time gap is used to accommodate the processing time of a RX UE, for example, including the PSCCH/PSSCH processing/decoding time and the generation time of HARQ feedback. Therefore, for a PSSCH transmission in slot n, its corresponding HARQ-ACK information should be sent in a slot n+t where t is the smallest inter equal to or larger than T and the slot n+t includes PSFCH resources. ‘a PSSCH transmission in slot n’ means ‘a last symbol of a PSSCH transmission in slot n’ or ‘a last slot of a PSSCH transmission in slot n’.

In the FIG. 11, for example, the time gap T is indicated to be equal to 2. Therefore, the HARQ information in response to the PSSCH reception in the slot 1104 may be transmitted in the PSFCH symbol of the slot 1107. Likewise, the HARQ information in response to the PSSCH reception in the slot 1105 may be transmitted in the PSFCH symbol of the slot 1107. On the other hand, given the gap between slot and slot cannot meet the time gap T=2, the HARQ information in response to the PSSCH reception in the slot 1106 may be transmitted in a slot including the PSFCH resource next to the slot 1107 if the time gap T=2 is met.

The slot including the PSFCH resources can be also called as PSFCH slot. The slot 1107 can be called as the PSFCH slot 1107. The slot 1104 is a PSSCH slot associated with the PSFCH slot 1107. The slot 1105 is a PSSCH slot associated with the PSFCH slot 1107. The slot 1106 is not a PSSCH slot associated with the PSFCH slot 1107. However, the slot 1106 can be a PSSCH slot associated with a PSFCH slot other than the PSFCH slot 1107. Therefore, in the FIG. 11, there are two PSSCH slots associated with the PSFCH slot 1107. It should be noted herein that a PSSCH slot means a last slot of a PSSCH reception if the PSSCH reception is scheduled by a SCI format over more than one slot.

Therefore, the TX/RX UEs may determine the time resource of PSFCH resources for a PSFCH transmission in response to the reception of a given PSSCH at least based on the information A. Time resource of PSFCH resources may include information on which slot and which symbol in the slot would be used for PSFCH transmission.

The resource pool configuration may provide the TX/RX UEs information B related to frequency resources for PSFCH reception/transmission.

In a case that interlaced PSFCH transmission is not configured in a resource pool, the information B may indicate a set of PRBs

$${M}_{PRB , set}^{PSFCH}$$

that are used for PSFCH transmission and reception in the resource pool. For a number of N_{subch} sub-channels for the resource pool, the UE may allocate

$${M}_{subch , slot}^{PSFCH}$$

PRBs from the

$${M}_{PRB , set}^{PSFCH}$$

PRBS to a PSSCH slot i among the PSSCH slots associated with the PSFCH slot and a sub-channel j. The

$${M}_{subch , slot}^{PSFCH} = {M}_{PRB , set}^{PSFCH} / ( {N}_{subch} \cdot {N}_{PSSCH}^{PSFCH} ) and 0 \leq i < {N}_{PSSCH}^{PSFCH} ,$$

$$0 \leq j < {N}_{subch} .$$

The allocation starts in an ascending order of i and continues in an ascending order of j.

In a case that interlaced PSFCH transmission is configured in a resource pool, the information B may indicate a set of interlaces that are used for PSFCH transmission and reception in the resource pool. PRBs of an interlace in the set in an RB set may be used by a TX/RX UEs for a PSFCH reception/transmission.

In this case, the information B may be a bitmap with M bits where each bit of the M bits corresponds to an interlace among the M interlaces. To be specific, the first (leftmost) bit of the bitmap corresponds to the interlace m=0, the second bit of the bitmap corresponds to the interlace m=1, and so on. In other words, the last (rightmost) bit of the bitmap corresponds to the interlace m=M−1. The leftmost bit can be also referred to the most significant bit. Similarly, the rightmost bit can be also referred to the least significant bit. If a bit value in the bitmap is set to 1, an interlace corresponding to the bit is allocated to the UE for a PSFCH transmission/reception. If a bit value in the bitmap is set to 0, an interlace corresponding to the bit is not allocated to the UE for a PSFCH transmission/reception.

In an example, the bitmap may be specific to an RB set included in the resource pool. That is, in a case that the resource pool is configured to include multiple RB sets, the information B may provide multiple bitmaps where each of the multiple bitmaps is associated with an RB set of the multiple RB sets included in the resource pool. According to configuration of bitmap specific to an RB set, the flexibility of PSFCH resource configuration in different RB sets can be achieved.

As in the FIG. 11, the resource pool includes two RB sets. The information B may provide two bitmaps where each bitmap is of Mbits. For example, a first bitmap used for the RB set 1101 is set to ‘01111’ which a second bitmap used for the RB set 1103 is set to ‘11110’. The TX/RX UEs may determine, based on the first bitmap, a first set of interlaces m=1, 2, 3, 4 are used or are available for PSFCH transmission and reception in the RB set 1101 of the resource pool. The TX/RX UEs may determine, based on the first bitmap, the interlace m=0 is not used or is unavailable for PSFCH transmission and reception in the RB set 1101 of the resource pool. Likewise, the TX/RX UEs may determine, based on the second bitmap, a second set of interlaces m=0, 1, 2, 3 are used or are available for PSFCH transmission and reception in the RB set 1103 of the resource pool. The TX/RX UEs may determine, based on the second bitmap, the interlace m=4 is not used or is unavailable for PSFCH transmission and reception in the RB set 1103 of the resource pool.

As in the PSFCH slot 1107, each block in the PSFCH symbol corresponds to a resource block of an interlace m. A block marked with cross mean a corresponding RB is not available for PSFCH transmission/reception. While a block not marked with cross mean a corresponding RB is available for PSFCH transmission/reception. In the RB set 1101, the RBs of the interlace m=0 are not available for PSFCH transmission. In the RB set 1103, the RBs of the interlace m=4 are not available for PSFCH transmission.

Additionally or alternatively, if the TX/RX UEs are not provided the information of the bitmap(s), the TX/RX UEs may determine all the M interlaces can be used for PSFCH transmission/reception in the resource pool.

In an example, the bitmap may be a common bitmap which are used for all RB sets included in the resource pool. That is, regardless of whether the resource pool include one RB set or multiple RB sets, the information B may provide one bitmap. The TX/RX UEs may determine, based on the one bitmap, a set of interlaces m are used or are available for PSFCH transmission and reception in all RB set(s) included in the resource pool.

Hereinafter, for purposes of illustrations,

$${M}_{Interlace}^{PSFCH , RB set r}$$

denotes a total number of interlaces in a set of interlaces that are available for PSFCH in an RB set with the RB set index r.

$${N}_{subch}^{RB set r}$$

denotes a total number of sub-channels included in an RB set with the RB set index i. The value of the

$${N}_{subch}^{RB set r}$$

may be calculated as (M mod K). Upon determining a set of interlaces available for PSFCH in an RB set of the resource pool, the TX/RX UE may further determine, in the RB set, to allocate one or more interlaces from the set to a PSSCH slot and a sub-channel. The total number of the one or more interlaces is determined or calculated based on the value of

$${M}_{Interlace}^{PSFCH , RB set r} ,$$

the value of

$${N}_{subch}^{RB set r}$$

and the value of

$${N}_{PSSCH}^{PSFCH} .$$

a resource pool, the value of

$${M}_{Interlace}^{PSFCH , RB set r}$$

may be as same as or different from each other. For different RB sets in a resource pool, the value of

$${N}_{subch}^{RB set r}$$

may be as same as or different from each other. For different RB sets in a resource pool, the value of

$${N}_{PSSCH}^{PSFCH}$$

is same.

$${M}_{subch , slot}^{PSFCH , RB set r}$$

denotes a total number of the one or more interlaces which are allocated to a PSSCH slot and a sub-channel in an RB set with the RB set index i. The value of

$${M}_{subch , slot}^{PSFCH , RB set r}$$

may be calculated according to

$${M}_{subch , slot}^{PSFCH , RB set r} = {M}_{Interlace}^{PSFCH , RB set r} / ( {N}_{subch}^{RB set r} \cdot {N}_{PSSCH}^{PSFCH} ) .$$

Then every

$${M}_{subch , slot}^{PSFCH , RB set r}$$

interlaces from the set of interlaces are allocated to a PSSCH slot and a sub-channel in an ascending order of slot index and then in an ascending order of sub-channel index in the RB set r. To be specific, the first

$${M}_{subch , slot}^{PSFCH , RB set r}$$

interlaces are allocated to the first sub-channel in the first PSSCH slot among the PSSCH slots, the second

$${M}_{subch , slot}^{PSFCH , RB set r}$$

interlaces are allocated to the first sub-channel in the second PSSCH slot among the PSSCH slots, and so on. Herein, the first

$${M}_{subch , slot}^{PSFCH , RB set r}$$

interlaces refer to the

$${M}_{subch , slot}^{PSFCH , RB set r}$$

interlaces in the set starting from the lowest interlace index in the set of interlaces.

In the FIG. 11, for example, the RB set 1101 (i.e., the RB set with the RB index r=0) includes

$${N}_{subch}^{RB set 0} = 1$$

subchannel, that is the RB set 1101 includes a first sub-channel in each slot. As above-mentioned,

$${M}_{Interlace}^{PSFCH , RB set 0}$$

is equal to 4. Therefore, the value of

$${M}_{subch , slot}^{PSFCH , RB set 0}$$

is calculated as 2. That is, every

$${M}_{subch , slot}^{PSFCH , RB set 0} = 2$$

interlaces from the set of interlaces are allocated to a slot and a sub-channel in the RB set 1101. In other words, two interlaces m=1, 2 (i.e., the first

$${M}_{subch , slot}^{PSFCH , RB set r} = 2$$

interlaces) are allocated to or associated with the PSSCH slot 1104 and the first sub-channel in the RB set 1101. Two interlaces m=3,4 (i.e., the second

$${M}_{subch , slot}^{PSFCH , RB set r} = 2$$

interlaces) are allocated to or associated with the PSSCH slot 1105 and the first sub-channel in the RB set 1101.

In another example, the RB set 1101 (i.e., the RB set with the RB index r=0) includes

$${N}_{subch}^{RB set 0} = 2$$

subchannel, that is the RB set 1101 includes a first sub-channel and a second sub-channel in each slot. The first sub-channel has a lower sub-channel index than the second sub-channel. As above-mentioned,

$${M}_{Interlace}^{PSFCH , RB set 0}$$

is equal to 4. Therefore, the value of

$${M}_{subch , slot}^{PSFCH , RB set 0}$$

is calculated as 1. That is, every

$${M}_{subch , slot}^{PSFCH , RB set 0} = 1$$

interlace from the set of interlaces is allocated to a slot and a sub-channel in the RB set 1101. In other words, the interlace m=1 is allocated to the PSSCH slot 1104 and the first sub-channel in the RB set 1101. The interlace m=2 is allocated to the PSSCH slot 1105 and the first sub-channel in the RB set 1101. The interlace m=3 is allocated to the PSSCH slot 1104 and the second sub-channel in the RB set 1101. The interlace m=4 is allocated to the PSSCH slot 1105 and the second sub-channel in the RB set 1101.

Likewise, for example, the RB set 1103 (i.e., the RB set with the RB index r=1) includes

$${N}_{subch}^{RB set 0} = 1$$

subchannel (i.e., a first sub-channel in the RB set 1103). As above-mentioned,

$${M}_{Interlace}^{PSFCH , RB set 1}$$

is equal to 4. Therefore, the value of

$${M}_{subch , slot}^{PSFCH , RB set 1}$$

is calculated as 2. That is,

$${M}_{subch , slot}^{PSFCH , RB set 1} = 2$$

interlaces are allocated to a slot and a sub-channel in the RB set 1103. The allocation of the interlaces can be also determined in an ascending order of slot index and then in an ascending order of sub-channel index in the RB set 1103. In other words, two interlaces m=0,1 are allocated to the PSSCH slot 1104 and the first sub-channel in the RB set 1103. Two interlaces m=2,3 are allocated to the PSSCH slot 1105 and the first sub-channel in the RB set 1103.

In the present disclosure, code division multiplexing (CDM) for multiple RX UEs may be supported in a same time-frequency resource for a PFSCH transmission. The time resource for a PSFCH transmission is an OFDM symbol. The frequency resource for a PSFCH transmission may be a PRB of the resource pool or multiple PRBs of an interlace in an RB set, which are depending on whether the interlaces PSFCH transmission is configured in the resource pool or not.

Regarding the CDM manner, the sequences sharing the same time-frequency resource (i.e., the same interlace in the same PSFCH symbol in the same RB set) may be orthogonal to each other so that a TX UE receiving the sequences can differentiate these orthogonal sequences. These kind of orthogonal sequences can be generated by using a same base sequence but with different cyclic shifts. A low PAPR sequence (i.e. Zadoff-Chu sequence) with length 12 is used as a base sequence for the PSFCH format 0. UP to 12 different phase rotations, i.e., 12 different cyclic shifts, in time domain can be applied to a same base sequence. Different cyclic shifts represent different HARQ-ACK information. The sequence of length 12 for PSFCH format 0 is mapped to 12 subcarriers of one PRB. For interlaced PSFCH transmission, the sequence of length 12 for PSFCH format 0 may be repeated in each resource block of an interlace in an RB set.

In order to transmit a PSFCH with HARQ-ACK information using PSFCH format 0, the RX UE needs to compute a value of cyclic shift a to generate the sequence for PSFCH format 0. The cyclic shift a is computed based on at least an initial cyclic shift value m₀ and a sequence cyclic shift value m_{cs}. For example, the value of the cyclic shift a is equal to the summation of the initial cyclic shift m₀ and the sequence cyclic shift m_{cs}. In the present disclosure, the resource pool configuration may provide the TX/RX UEs information C related to code domain resources (a set of cyclic shift pairs) for PSFCH transmission. The information C may include a number of cyclic shift pairs for the resource pool which may be indicated by a parameter included in the resource pool. The number of cyclic shift pairs can be multiplexed in a PRB or PRBs of interlaces in an RB set for a PSFCH transmission. That is, the number of cyclic shift pairs can determine how many PSFCH resources can be assigned within a same time-frequency resource for a PSFCH transmission. That is, different cyclic shift pairs can be assigned to different RX UEs in the same time-frequency resource for a PSFCH transmission.

Hereinafter,

$${N}_{cs}^{PSFCH}$$

denotes the number of cyclic shift pairs for a resource pool. The

$${N}_{cs}^{PSFCH}$$

cyclic shift pairs can be indexed from 0, 1, . . . ,

$${N}_{cs}^{PSFCH} - 1.$$

A cyclic shift pair can be used by the TX/RX UE to at least determine or calculate the initial cyclic shift value m₀ from the cyclic shift pair. The

$${N}_{cs}^{PSFCH}$$

cyclic shirt pairs correspond to their respective

$${N}_{cs}^{PSFCH}$$

initial cyclic shift values. The determination of the

$${N}_{cs}^{PSFCH}$$

cyclic shift pairs and their respective

$${N}_{cs}^{PSFCH}$$

initial cyclic shift values can be predefined in a table. That is, the UE can determine the initial cyclic shift value according to the parameter indicating the value of

$${N}_{cs}^{PSFCH}$$

and a predefined table.

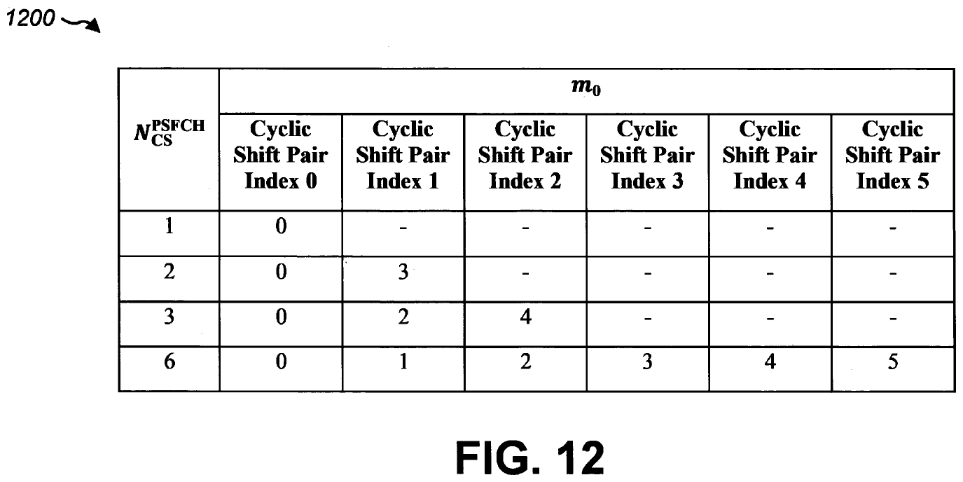

For example, FIG. 12 is a diagram illustrating one example 1200 of a set of cyclic shift pair. FIG. 12 specifies a predefined Table 1200 for mapping determination between the initial cyclic shift values and cyclic shift pairs indexes. As in the FIG. 12, in a case that the

$${N}_{cs}^{PSFCH}$$

is equal to 1, there is only one cyclic shift pair, i.e., the cyclic shift pair index 0. In a case that the

$${N}_{cs}^{PSFCH}$$

is equal to 2, there is two cyclic shift pairs, i.e., the cyclic shift pair index 0 and the cyclic shift pair index 1.

According to the FIG. 12, each cyclic shift pair index corresponds to an initial cyclic shift value m₀. For example, when

$${N}_{cs}^{PSFCH}$$

is equal to 2, the cyclic shift pair index 1 corresponds to the initial cyclic shift m₀=3. While when

$${N}_{cs}^{PSFCH}$$

is equal to 3, the cyclic shift pair index 1 corresponds to the initial cyclic shift m₀=1. A same cyclic shift pair index may correspond to different initial cyclic shift values if the values of the corresponding

$${N}_{cs}^{PSFCH}$$

are different. For each

$${N}_{cs}^{PSFCH} ,$$

the UE 102 can determine an initial cyclic shift value for each cyclic shift par index according to the predefined table specified in the FIG. 12.

The UE 102 (e.g., the control unit of the UE 102) may need to further determine a sequence cyclic shift value for the sequence used for a PSFCH transmission using the PSFCH format 0. Different sequence cyclic shift values indicate different values of HARQ-ACK information bit(s). Different values of HARQ-ACK information bit(s) represent different HARQ-ACK information. For example, a HARQ-ACK information bit value of 0 represents a NACK while a HARQ-ACK information bit value of 1 represents a ACK. For example, values (0, 0) of two HARQ-ACK information bits represent (NACK, NACK), values (0, 1) of two HARQ-ACK information bits represent (NACK, ACK), values (1, 0) of two HARQ-ACK information bits represent (ACK, NACK), and values (1, 1) of two HARQ-ACK information bits represent (ACK, ACK). In other words, the sequence cyclic shift value m_{cs} is determined from the value of one HARQ-ACK information bit or from the values of two HARQ-ACK information bits.

In an example A of an implementation of the present disclosure, a RX UE may transmit, to a TX UE, a PSFCH transmission with one HARQ-ACK information bit using PSFCH format 0. In the example, a TX UE may receive, from a RX UE, a PSFCH transmission with one HARQ-ACK information bit using PSFCH format 0. The RX/TX UEs may be (pre-)configured with the number,

$${N}_{cs}^{PSFCH} ,$$

of cyclic snit pairs for a resource pool. The value of

$${N}_{cs}^{PSFCH}$$

may be configured as one of 1, 2, 3, and 6. The TX/RX UEs may determine, based on the value of

$${N}_{cs}^{PSFCH}$$

and the predefined table 1200, the

$${N}_{cs}^{PSFCH}$$

initial cyclic shift values corresponding to their respective

$${N}_{cs}^{PSFCH}$$

cyclic shift pair indexes.

In the example A, the RX UE may determine the sequence cyclic shift value m_{cs} based on the value of the one HARQ-ACK information bit. Specifically, the sequence cyclic shift value is determined from a set A of two sequence cyclic shift values. The set A includes two sequence cyclic shift values {0, 6} where the sequence cyclic shift value 0 is mapped to value 0 of the one HARQ-ACK information bit (i.e., NACK) and the sequence cyclic shift value 6 is mapped to value 1 of the one HARQ-ACK information bit (i.e., ACK). Then, the cyclic shift value a of the sequence for a PSFCH transmission may be determined based on the determined initial cyclic shift value m₀ and the determined sequence cyclic shift value m_{cs}.

According to the set A and the initial cyclic shift value of a cyclic shift pair index, two cyclic shift values included in each cyclic shift pair index can be determined as m₀ and (m₀+6). For example, in case of the

$${N}_{cs}^{PSFCH} = 1 ,$$

there are one cyclic shift pair index which includes two cyclic shift values 0 and 6. In case of the

$${N}_{cs}^{PSFCH} = 2 ,$$

there are two cyclic shift pair indexes. The cyclic shift pair index 0 includes two cyclic shift values 0 and 6, while the cyclic shift pair index 1 includes two cyclic shift values 3 and 9. The cyclic shift values of the cyclic shift pair index 0 can be used by a RX UE to send HARQ-ACK information. And the cyclic shift values of the cyclic shift pair index 1 can be used by another RX UE to send HARQ-ACK information. A TX UE may detect the PSFCH transmission. And the TX UE can differentiate, based on the detected cyclic shift value, which UE send the HARQ-ACK information and what is the send HARQ-ACK information.

In an example B of an implementation of the present disclosure, a RX UE may transmit, to a TX UE, a PSFCH transmission with two HARQ-ACK information bits using PSFCH format 0. In the example, a TX UE may receive, from a RX UE, a PSFCH transmission with two HARQ-ACK information bit using PSFCH format 0. The RX/TX UEs may be (pre-)configured with the number

$${N}_{cs}^{PSFCH} ,$$

of cyclic shift pairs for a resource pool. Given two HARQ-ACK information bits would occupy four cyclic shift values, the value of

$${N}_{cs}^{PSFCH}$$

therefore may not be configured as 6 and the value of

$${N}_{cs}^{PSFCH}$$

may be configured as one of 1, 2, 3. The TX/RX UEs may determine, based on the value of

$${N}_{cs}^{PSFCH}$$

and predefined table 1200, the

$${N}_{cs}^{PSFCH}$$

initial cyclic shift values corresponding to their respective

$${N}_{cs}^{PSFCH}$$

cyclic shift pair indexes.

In the example B, the RX UE may determine the sequence cyclic shift value m_{cs} based on the values of the two HARQ-ACK information bits. Specifically, the sequence cyclic shift value is determined from a set B of four sequence cyclic shift values. The set B includes four sequence cyclic shift values {0, 3, 6, 9} where the sequence cyclic shift value 0 is mapped to value (0, 0) of the two HARQ-ACK information bits, the sequence cyclic shift value 3 is mapped to value (0, 1) of the two HARQ-ACK information bits, the sequence cyclic shift value 6 is mapped to value (1, 1) of the two HARQ-ACK information bits, and the sequence cyclic shift value 9 is mapped to value (1, 1) of the two HARQ-ACK information bits.

Different values between every two consecutive sequence cyclic shift values in the set B are equal to each other. Difference values between every two consecutive sequence cyclic shift values in the set B are equal to the value C. In the set B, different values between every two consecutive sequence cyclic shift values are equal to 3. In other words, these four cyclic shift values have an equal but farthest phase rotation distance in the frequency domain. According to the characteristic of the four sequence cyclic shift values in the set B, the detection preformation among (NACK, NACK), (NACK, ACK), (ACK, ACK) and (NACK, ACK) can be maximized. However, the set B cannot be applied to all the case of the N_{cs}^{PSFCH}. For example, for a case that N_{cs}^{PSFCH} is equal to 2, if the set B is applied, cyclic shift pair index 0 would include four cyclic shift values {0, 3, 6, 9} while cyclic shift pair index 1 would include four cyclic shift values {3, 6, 9, 0}. Two cyclic shift pair indexes would have same four cyclic shift values so that HARQ-ACK feedbacks from different RX UEs cannot be multiplexed in the same time-frequency resource for a PSFCH transmission. A TX UE cannot distinguish which UE send the HARQ-ACK information and the contents of the send HARQ-ACK information.

In the present disclosure, another set of four sequence cyclic shift values (set C) is introduced to address the issue. That is, the sequence cyclic shift value may be also determined from the set C of four sequence cyclic shift values. The set C includes four sequence cyclic shift values {0, 2, 6, 8} (or {0, 4, 6, 10}) where the sequence cyclic shift value 0 is mapped to value (0, 0) of the two HARQ-ACK information bits, the sequence cyclic shift value 2 (or 4) is mapped to value (0, 1) of the two HARQ-ACK information bits, the sequence cyclic shift value 6 is mapped to value (1, 1) of the two HARQ-ACK information bits, and the sequence cyclic shift value 8 (or 10) is mapped to value (1, 1) of the two HARQ-ACK information bits. Difference values between every two consecutive sequence cyclic shift values in the set C are unequal to the value C, that is, the phase rotation distances between every two consecutive sequence cyclic shift values in the set C are unequal to π/2 in the frequency domain. The value C may be 3.

In the example B, the UE may determine a sequence cyclic shift value for a sequence used for a PSFCH transmission from the set B or the set C based on the value of the

$${N}_{cs}^{PSFCH} .$$

In a case that the value of

$${N}_{cs}^{PSFCH}$$

is equal to a value A, the sequence cyclic shift value is determined from the set C of four sequence cyclic shift values. In a case that the value of

$${N}_{cs}^{PSFCH}$$

is equal to a value B, the sequence cyclic shift value is determined from the set B of four sequence cyclic shift values. The value A may be 2. The value B may be an integer other than 2, for example, 1 or 3.

In the example B, additionally or alternatively, the UE may determine a sequence cyclic shift value for a sequence used for a PSFCH transmission from the set B or the set C based on whether the difference between two initial cyclic shift values from the

$${N}_{cs}^{PSFCH}$$

initial cyclic shift values is equal to the value C or not. In a case that a difference between two initial cyclic shift values from the

$${N}_{cs}^{PSFCH}$$

initial cyclic shift values is equal to the value C, the sequence cyclic shift value is determined from the set C of four sequence cyclic shift values. In a case that a difference between two initial cyclic shift values from the

$${N}_{cs}^{PSFCH}$$

initial cyclic shift values is not equal to the value C, the sequence cyclic shift value is determined from the set B of four sequence cyclic shift values.

Additionally or alternatively, in a case that the value of

$${N}_{cs}^{PSFCH}$$

is equal to the value A and a difference between two initial cyclic shift values from the

$${N}_{cs}^{PSFCH}$$

initial cyclic shift values is equal to the value C, the sequence cyclic shift value is determined from the set C. In a case that the value of

$${N}_{cs}^{PSFCH}$$

is equal to the value B and a difference between any two initial cyclic shift values from

$${N}_{cs}^{PSFCH}$$

initial cyclic shift values is not equal to any multiple of the value C, the sequence cyclic shift value is determined from the set B. A multiple of the value C herein may refer to, for example, 3, 6, or 9.

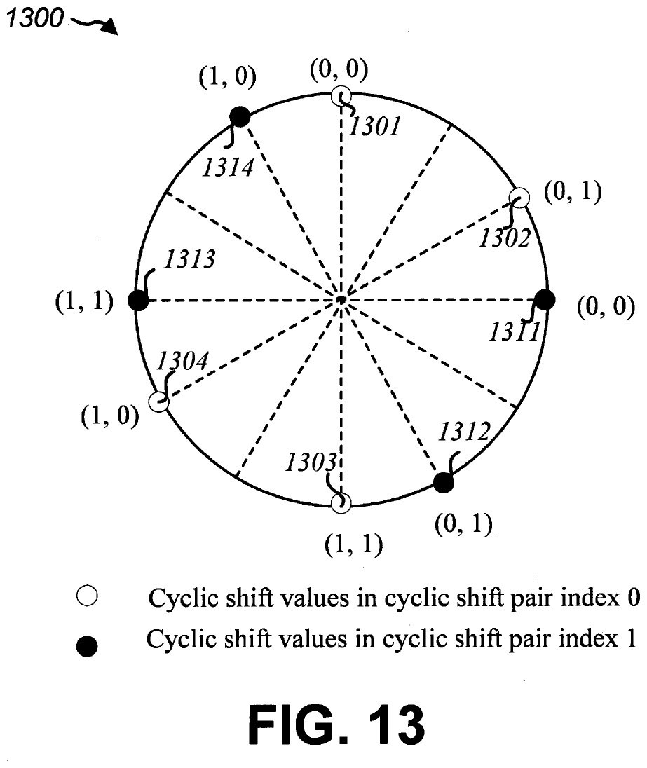

FIG. 13 is a diagram illustrating an example 1300 of cyclic shifts for cyclic shift pair index 0 and index 1. In the FIG. 13, for example, the value of

$${N}_{cs}^{PSFCH}$$

is equal to 2. As above-mention, 12 different cyclic shifts in time domain can be applied to a same base sequence, that is, 12 different phase rotations can be defined for the same base sequence. Applying a cyclic shift in the time domain is equivalent to a linear phase rotation in the frequency domain. Therefore, in the present disclosure, ‘a cyclic shift’ may also be referred to as ‘a phase rotation’. In the FIG. 13, 12 phase rotations (12 cyclic shifts) are separated with 2π/12. In other words, the increment of 1 in the cyclic shift value means the increment of 2π/12 in the phase rotation.

According to the FIG. 12, the initial cyclic shift value corresponding to the cyclic shift pair index 0 is 0, while the initial cyclic shift value corresponding to the cyclic shift pair index 1 is 3. As in the FIG. 13, 1301 denotes the initial cyclic shift value of the cyclic shift pair index 0. The initial cyclic shift value 1301 may also refer to reference phase rotation for the cyclic shift pair index 0. Likewise, 1311 denotes the initial cyclic shift value of the cyclic shift pair index 1. The initial cyclic shift value 1311 may also refer to reference phase rotation for the cyclic shift pair index 1.

According to the example B, the set C with {0, 2, 6, 8} is used to determine the sequence cyclic shift value. Therefore, the cyclic shift pair index 0 may include four cyclic shift values with {0, 2, 6, 8}, while the cyclic shift pair index 1 may include four cyclic shift values with {3, 5, 9, 11}.

As shown in the FIG. 13, the 1301 also represents the cyclic shift value (a=0) corresponding to values (0, 0) of two HARQ-ACK information bits. The 1302 represents the cyclic shift value (a=2) corresponding to values (0, 1) of two HARQ-ACK information bits. The 1303 represents the cyclic shift value (a=6) corresponding to values (1, 1) of two HARQ-ACK information bits. The 1304 represents the cyclic shift value (a=8) corresponding to values (1, 0) of two HARQ-ACK information bits.

Likewise, the 1311 also represents the cyclic shift value (a=3) corresponding to values (0, 0) of two HARQ-ACK information bits. The 1312 represents the cyclic shift value (a=5) corresponding to values (0, 1) of two HARQ-ACK information bits. The 1313 represents the cyclic shift value (a=9) corresponding to values (1, 1) of two HARQ-ACK information bits. The 1314 represents the cyclic shift value (a=11) corresponding to values (1, 0) of two HARQ-ACK information bits.

According to the solution provided in the example B, by applying the set C for

$${N}_{cs}^{PSFCH} = 2 ,$$

the cyclic shifts in the cyclic shift pair index 0 do not overlap with those in the cyclic shift pair index 1. Therefore, two different RX UE can be multiplexed in a same time-frequency resource for a PSFCH transmission. Furthermore, by applying the set C, for each cyclic shift pair index, the phase rotation distance between a phase rotation representing (0, 0) and the other phase rotation representing (1, 1) is guaranteed to be farthest so that the performance for detecting (0, 0) and (1, 1) can be maximized. In addition to the phase rotation distance between (0,0) and (1,1), the phase rotation distance between other two HARQ-ACK information is also kept being a reasonable distance.

Additionally or alternatively, in order to solve the issue of cyclic shift overlapping in the cyclic shift pair index 0 and index 1, the UE may determine initial cyclic shift value for

$${N}_{cs}^{PSFCH} = 2$$

in a manner different from the determination specified in the predefined Table 1200. Specifically, in a case that the value of

$${N}_{cs}^{PSFCH}$$

is equal to 2 and the RX UE transmits a PSFCH transmission with one HARQ-ACK information bit using PSFCH format 0, the UE may determine the initial cyclic value is 0 for cyclic shift pair index 0 and determine the initial cyclic value is 3 for cyclic shift pair index 1. In a case that the value of

$${N}_{cs}^{PSFCH}$$

is equal to 2 and the RX UE transmits a PSFCH transmission with two HARQ-ACK information bits using PSFCH format 0, the UE may determine that determine the initial cyclic value is 0 for cyclic shift pair index 0 and determine the initial cyclic value is 2 (or 4) for cyclic shift pair index 1. Then for a PSFCH transmission with two HARQ-ACK information bits, the UE may further determine the sequence cyclic shift value m_{cs} from the set B depending on the HARQ-ACK information. Additionally, for a PSFCH transmission with one HARQ-ACK information bit, the UE may further determine the sequence cyclic shift value m_{cs} from the set A depending on the HARQ-ACK information.

In the present disclosure, the RX/TX UEs may be configured with the information A, information B and the information C. The RX/TX UEs may determine a set of PSFCH resources that are available for a PSFCH transmission with HARQ-ACK information in response to a PSSCH reception. Each PSFCH resource in the set comprises of an interlace in any RB set of the one or more RB sets in the frequency domain, an OFDM symbol in time domain, and a cyclic shift pair index in code domain. In other words, each PSFCH resource in the set is mapped to an interlace in any RB set of the one or more RB sets in the frequency domain, an OFDM symbol in time domain, and a cyclic shift pair index in code domain.

The OFDM symbol refers to the above-mentioned PSFCH symbol. The number,

$${N}_{cs}^{PSFCH} ,$$

of cyclic shift pair indexes is indicated by a parameter included in the SL resource pool configuration. The

$${N}_{cs}^{PSFCH}$$

cycle shift pair indexes can be multiplexed in an interlace of an RB set. The one or more RB sets may be the RB set(s) allocated for the PSSCH reception. The one or more RB sets may be a subset of RB sets which are included in the resource pool. Alternatively, the one or more RB sets may be all RB sets of the resource pool. For purposes of illustration, the RB sets of the resource pool may refer to a first set of RB sets. The one or more RB set which are allocated for a PSSCH reception may refer to a second set of RB sets.

For an RB set r in the second set, the UE may determine a set of PSFCH resources in the RB set r of the resource pool where the set of PSFCH resources are available for multiplexing HARQ-ACK in a PSFCH transmission in response to the PSSCH reception. To be specific, the UE may determine a set of PSFCH resources in the RB set r of the resource pool as

$${N}_{interlace , CS}^{PSFCH , RB set r} = {N}_{type}^{PSFCH} \cdot {M}_{subch , slot}^{PSFCH , RB set r} \cdot {N}_{CS}^{PSFCH} .$$

A parameter (e.g., sl-PSFCH-CandidateResourceType) may be used to indicate the value of

$${N}_{type}^{PSFCH} .$$

In a case that the parameter is set to a value (e.g., startSubCH), the value of

$${N}_{type}^{PSFCH}$$

is equal to 1. In this case, the

$${M}_{subch , slot}^{PSFCH , RB set r}$$

are associated with the PSSCH slot where the PSSCH is transmitted and a starting sub-channel (a lowest sub-channel index) of the PSSCH in the RB set r. In a case that the parameter is set to a value (e.g., allocSubCH), the value of

$${N}_{type}^{PSFCH}$$

is equal to

$${N}_{subch}^{PSSCH , RB set r} .$$

In this case, the

$${N}_{subch}^{PSSCH , RB set r} * {N}_{subch}^{PSSCH , RB set r}$$

interlaces are associated with the

$${N}_{subch}^{PSSCH , RB set r}$$

sub-channel(s) of the PSSCH in the RB set r.

In a case that the PSSCH is transmitted in more than one RB set (i.e., there are more than one RB set in the second set), the UE may further a set of PSFCH resources for each RB set in the second set. After determining the PSFCH resources for each RB set in the second set, a total number of PSFCH resource associated with the PSSCH reception is calculated as the summation of all the determined PSFCH resources for each RB set in the second set. That is, a total set of PSFCH resources for a PSSCH reception may include all sets of PSFCH resources for all RB sets in the second set. For the RB sets in the second set, the number of determined PSFCH resources for an RB set may be same as or different from that for another RB set. Each PSFCH resource in the total set comprises of an interlace in any RB set of the second set in frequency domain, an OFDM symbol in time domain, and a cyclic shift pair index in code domain. Each PSFCH resource in the total set is mapped to an interlace in an RB set of the second set in frequency domain, an OFDM symbol in the time domain and a cyclic shift pair index in code domain.

HARQ-ACK information for a PSSCH reception in a resource pool can only be send in a PFSCH resource associated to the PSSCH reception. In other words, HARQ-ACK information for a first PSSCH reception in a resource pool may be send in a PFSCH resource associated to the first PSSCH reception and would not send in a PSFCH resource associated to a PSSCH reception other than the first PSSCH reception. Additionally or alternatively, HARQ-ACK information for a PSSCH reception in a resource pool may be sent in an RB set where the PSSCH is allocated and may not be sent in an RB set where the PSSCH is not allocated.

After determining the total set of PSFCH resources, the UE may determine to index each PSFCH resource in the total set based on its corresponding RB set index, its corresponding interlace index, and its corresponding cyclic shift pair index. The indexing of the PSFCH resources is determined in the following orders where first, in increasing order of the interlace index within an RB set from the second set; second, in increasing order of RB set indexes in the second set; third, in increasing order of the cyclic shift pair index from the

$${N}_{CS}^{PSFCH}$$

cyclic shift pairs.

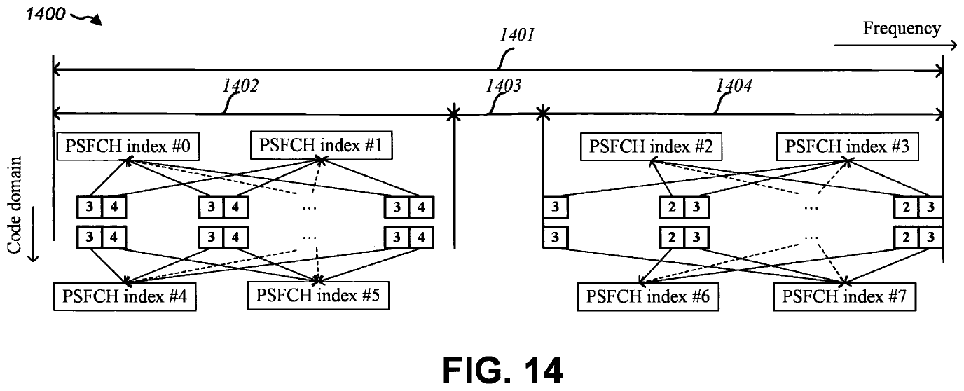

FIG. 14 is a diagram illustrating one example 1400 of indexing PSFCH resources for a given PSSCH. In the FIG. 14, the value of

$${N}_{CS}^{PSFCH}$$

is set to 2 and the parameter (e.g., sl-PSFCH-CandidateResourceType) is set to allocSubCH. A resource pool 1401 in the frequency domain includes two RB sets 1402 and 1404 and one intra-cell guard band 1403. The RB set 1402 is an RB set with the RB index r=0. The RB set 1404 is an RB set with the RB index r=1. The FIG. 14 is used to further index the PSFCH resources which are illustrated in FIG. 11 for a PSSCH reception in a PSSCH slot. The RB set 1402 and the RB set 1101 can be used interchangeably, while the RB set 1404 and the RB set 1103 can be also used interchangeably.

A RX UE may receive a PSSCH transmission where the PSSCH is scheduled in the first sub-channel of the RB set 1101 and the first sub-channel of the RB set 1103 in the frequency domain and is scheduled in the PSSCH slot 1105 in the time domain. Here,

$${N}_{subch}^{RB set 0}$$

is assumed to 1 and

$${N}_{subch}^{RB set 1}$$

is assumed to 1 as well. Then, the value of

$${N}_{subch}^{PSSCH , RB set r}$$

is equal to 1 for both the RB set 1402 and the RB set 1404. According to the illustration in the FIG. 11,

$${M}_{subch , slot}^{PSFCH , RB set 0} = 2 and {M}_{subch , slot}^{PSFCH , RB set 1} = 2.$$

The number of PSFCH resources associated with the PSSCH reception in the RB set 1402 is determined as 4. Likewise, the number of PSFCH resources associated with the PSSCH reception in the RB set 1404 is determined as 4. Then the total number of PSFCH resources available for a PSFCH transmission in response to the PSSCH reception is the summation of the number of PSFCH resources determined for the RB set 1402 and the number of PSFCH resources determined for the RB set 1404, i.e., 4+4=8.

The indexing of the PSFCH resources is determined in the following orders where first, in increasing order of the interlace index within an RB set from the second set; second, in increasing order of RB set indexes in the second set; third, in increasing order of the cyclic shift pair index from the

$${N}_{CS}^{PSFCH}$$

cyclic shift pairs.

According to orders, the PSFCH resource index #0 is assigned to a PSFCH resource which comprises of the interlace m=3 (i.e., the lowest interlace index in the RB set 1402) in the RB set index r=0 and the cyclic shift index 0. The PSFCH resource index #1 is assigned to a PSFCH resource which comprises of the interlace m=4 in the RB set index r=0 and the cyclic shift index 0. The PSFCH resource index #2 is assigned to a PSFCH resource which comprises of the interlace m=2 (i.e., the lowest interlace index in the RB set 1404) in the RB set index r=1 and the cyclic shift index 0. The PSFCH resource index #3 is assigned to a PSFCH resource which comprises of the interlace m=3 in the RB set index r=1 and the cyclic shift index 0. The PSFCH resource index #4 is assigned to a PSFCH resource which comprises of the interlace m=3 (i.e., the lowest interlace index in the RB set 1402) in the RB set index r=0 and the cyclic shift index 1. The PSFCH resource index #5 is assigned to a PSFCH resource which comprises of the interlace m=4 in the RB set index r=0 and the cyclic shift index 1. The PSFCH resource index #6 is assigned to a PSFCH resource which comprises of the interlace m=2 (i.e., the lowest interlace index in the RB set 1404) in the RB set index r=1 and the cyclic shift index 1. The PSFCH resource index #7 is assigned to a PSFCH resource which comprises of the interlace m=3 in the RB set index r=1 and the cyclic shift index 1.

Among the 8 PSFCH resources with respective indexes, the RX UE may determine, based on a first identity and/or a second identity, an PSFCH resource index which is used as actual PSFCH resource for PSFCH transmission. The first identity may refer to a physical layer source ID of a TX UE which is provided by a SCI format scheduling the PSSCH. The second identity may refer to an identity of the RX UE.

According to the above indexing order, each PSFCH resource which are available for a PSFCH transmission in response to the PSSCH reception can be indexed with a unique number. A more efficient PSFCH transmission over unlicensed spectrum is provided.

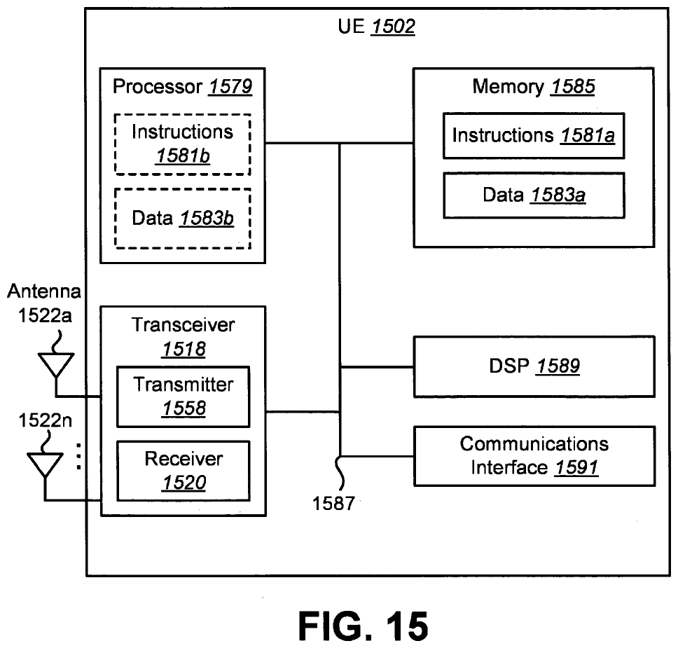

FIG. 15 illustrates various components that may be utilized in a UE 1502. The UE 1502 (UE 102) described in connection with FIG. 15 may be implemented in accordance with the UE 102 described in connection with FIG. 1. The UE 1502 includes a processor 1581 that controls operation of the UE 1502. The processor 1581 may also be referred to as a central processing unit (CPU). Memory 1587, which may include read-only memory (ROM), random access memory (RAM), a combination of the two or any type of device that may store information, provides instructions 1583a and data 1585a to the processor 1581. A portion of the memory 1587 may also include non-volatile random access memory (NVRAM). Instructions 1583b and data 1585b may also reside in the processor 1581. Instructions 1583b and/or data 1585b loaded into the processor 1581 may also include instructions 1583a and/or data 1585a from memory 1587 that were loaded for execution or processing by the processor 1581. The instructions 1583b may be executed by the processor 1581 to implement one or more of the methods described above.

The UE 1502 may also include a housing that contains one or more transmitters 1558 and one or more receivers 1520 to allow transmission and reception of data. The transmitter(s) 1558 and receiver(s) 1520 may be combined into one or more transceivers 1518. One or more antennas 1522a-n are attached to the housing and electrically coupled to the transceiver 1518.

The various components of the UE 1502 are coupled together by a bus system 1589, which may include a power bus, a control signal bus and a status signal bus, in addition to a data bus. However, for the sake of clarity, the various buses are illustrated in FIG. 15 as the bus system 1589. The UE 1502 may also include a digital signal processor (DSP) 1591 for use in processing signals. The UE 1502 may also include a communications interface 1593 that provides user access to the functions of the UE 1502. The UE 1502 illustrated in FIG. 15 is a functional block diagram rather than a listing of specific components.

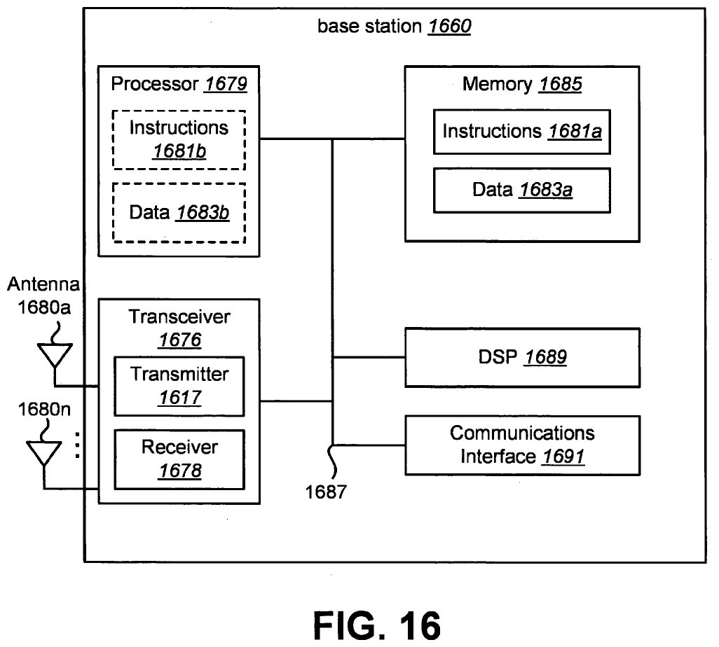

FIG. 16 illustrates various components that may be utilized in a base station 1660. The base station 1660 described in connection with FIG. 16 may be implemented in accordance with the base station 160 described in connection with FIG. 1. The base station 1660 includes a processor 1681 that controls operation of the base station 1660. The processor 1681 may also be referred to as a central processing unit (CPU). Memory 1687, which may include read-only memory (ROM), random access memory (RAM), a combination of the two or any type of device that may store information, provides instructions 1683a and data 1685a to the processor 1681. A portion of the memory 1687 may also include non-volatile random access memory (NVRAM). Instructions 1683b and data 1685b may also reside in the processor 1681. Instructions 1683b and/or data 1685b loaded into the processor 1681 may also include instructions 1683a and/or data 1685a from memory 1687 that were loaded for execution or processing by the processor 1681. The instructions 1683b may be executed by the processor 1681 to implement one or more of the methods 300 described above.

The base station 1660 may also include a housing that contains one or more transmitters 1617 and one or more receivers 1678 to allow transmission and reception of data. The transmitter(s) 1617 and receiver(s) 1678 may be combined into one or more transceivers 1676. One or more antennas 1680a-n are attached to the housing and electrically coupled to the transceiver 1676.

The various components of the base station 1660 are coupled together by a bus system 1689, which may include a power bus, a control signal bus and a status signal bus, in addition to a data bus. However, for the sake of clarity, the various buses are illustrated in FIG. 16 as the bus system 1689. The base station 1660 may also include a digital signal processor (DSP) 1691 for use in processing signals. The base station 1660 may also include a communications interface 1693 that provides user access to the functions of the base station 1660. The base station 1660 illustrated in FIG. 16 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using circuitry, a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

1-7. (canceled)

8. A user equipment (UE), comprising:
reception unit configured to receive, from another UE, a physical sidelink (SL) shared channel (PSSCH) in one or multiple resource block (RB) sets in a SL resource pool; and
control circuitry configured to determine a set of physical sidelink feedback channel (PSFCH) resources that are available for a PSFCH transmission with HARQ-ACK information in response to the PSSCH reception, wherein each PSFCH resource in the set comprises of an interlace within an RB set of the one or multiple RB sets in frequency domain, an OFDM symbol in time domain, and a cyclic shift pair index in code domain, and
to index PSFCH resources in the set based on an RB set index, an interlace index, a cyclic shift pair index.

9. The UE of the claim 8: wherein
the indexing of the PSFCH resources is determined by first in increasing order of the interlace index, second, in increasing order of RB set indexes of the one or multiple RB sets, and third, in increasing order of the cyclic shift pair index from N cyclic shift pairs.

10. The UE of the claim 9: wherein
the value of the N cyclic shift pairs is indicated by a parameter, the parameter being included in the SL resource pool configuration.

11. A communication method using a user equipment (UE), the communication method comprising:
receiving, from another UE, a physical sidelink (SL) shared channel (PSSCH) in one or multiple resource block (RB) sets in a SL resource pool; and
determining a set of physical sidelink feedback channel (PSFCH) resources that are available for a PSFCH transmission with HARQ-ACK information in response to the PSSCH reception, wherein each PSFCH resource in the set comprises of an interlace within an RB set of the one or multiple RB sets in frequency domain, an OFDM symbol in time domain, and a cyclic shift pair index in code domain, and
indexing PSFCH resources in the set based on an RB set index, an interlace index, a cyclic shift pair index.
